(19) United States
(12) Patent Application Publication
(10) Pub. No.: US 2025/0066516 A1
(43) Pub. Date: Feb. 27, 2025

(54) HYDROGENATED POLYBUTADIENE POLYMERS AND RUBBER COMPOSITIONS INCORPORATING SAME

(71) Applicant: BRIDGESTONE CORPORATION, Tokyo (JP)

(72) Inventors: Ryan J. HUE, Akron, OH (US); Rajith M. JAYASINHA ARACHCHIGE, North Canton, OH (US); Jeffrey M. MAGISTRELLI, Richfield, OH (US); Bret J. CHISHOLM, Peoria, IL (US)

(21) Appl. No.: 18/724,455

(22) PCT Filed: Dec. 28, 2022
(86) PCT No.: PCT/US2022/082469

§ 371 Date: Jun. 26, 2024

Related U.S. Application Data
(60) Provisional application No. 63/294,537, filed on Dec. 29, 2021.

(51) Int. Cl. C08F 36/06; C08C 19/02; C08C 19/25; C08K 3/04; C08K 3/06; C08K 3/36

(52) U.S. Cl. CPC C08F 36/06; C08C 19/02; C08C 19/25; C08K 3/04; C08K 3/06; C08K 3/36; C08F 2500/20; C08F 2500/32; C08F 2500/34

(57) ABSTRACT

Embodiments of the present disclosure are directed to polymers, wherein the polymers comprise hydrogenated 1,4-polybutadiene having a cis content of about 50% to about 96%, a vinyl content of about 0% to about 1%, and a trans content of about 1% to about 10%. The hydrogenated 1, 4-polybutadiene has a degree of hydrogenation of about 3% to about 50%.

### TECHNICAL FIELD

Embodiments of the present disclosure are generally related to hydrogenated polybutadiene polymers, and are specifically related to partially hydrogenated high-cis 1,4-polybutadiene rubber compositions equally suited for good tire performance at both low and high temperatures and non-tire applications.

### BACKGROUND

In tire manufacturing, high-cis polybutadiene (e.g., polymers with a cis-1,4 linkage content of 94% or greater) is commonly used due to its mechanical and viscoelastic properties. However, at lower temperatures of less than or equal to 0° C., these compositions are susceptible to crystallization. Crystallization may stiffen the tire at these lower temperatures, reducing traction during snowy and icy conditions. These compositions may possess crystallites having a peak melting temperature equal to or above 100° C.

Accordingly, a continual need exists for improved 1,4-polybutadiene rubber compositions which resist formation of crystals of cis-1,4 butadiene units at low temperature crystallization and yield high temperature melting crystallites.

### SUMMARY

Embodiments of the present disclosure are directed to partially hydrogenated high-cis 1,4-polybutadiene compositions which provide good tire performance at both low and high temperatures and non-tire applications.

According to one embodiment, a polymer is provided. The polymer comprises partially hydrogenated 1,4-polybutadiene having a cis content of about 50% to about 96%, a vinyl content of about 0% to about 1%, and a trans content of about 1% to about 10%. The partially hydrogenated 1,4-polybutadiene has a degree of hydrogenation of about 3% to about 50%.

According to another embodiment, a method is provided. The method comprises polymerizing a solution comprising 1,3-butadiene to yield 1,4-polybutadiene having a cis content of about 50% to about 99.5%, a vinyl content of about 0.1% to about 1%, and a trans content of about 1% to about 10%, wherein the polymerization is catalyzed with a lanthanide metal complex or a nickel metal complex; and hydrogenating the 1,4-polybutadiene to form hydrogenated 1,4-polybutadiene having a degree of hydrogenation of about 3% to about 50%, wherein the hydrogenation is catalyzed with a metal catalyst

Additional features and advantages of the embodiments described herein will be set forth in the detailed description which follows, and in part will be readily apparent to those skilled in the art from that description or recognized by practicing the embodiments described herein, including the detailed description which follows, and the claims.

### DETAILED DESCRIPTION

Embodiments of the present disclosure are directed to polymers. The polymers may comprise partially hydrogenated 1,4-polybutadiene having a cis content of about 50% to about 96%, a vinyl content of about 0% to about 1%, and a trans content of about 1% to about 10%. The partially hydrogenated 1,4-polybutadiene may have a degree of hydrogenation of about 3% to about 50%. In other embodiments, the partially hydrogenated 1,4-polybutadiene may have a degree of hydrogenation of about 5% to about 50%

The disclosure should not be construed as limited to the embodiments set forth herein. Rather, these embodiments are provided so that this disclosure will be thorough and complete, and will fully convey the subject matter to those skilled in the art.

### Definitions

Unless otherwise defined, all technical and scientific terms used herein have the same meaning as commonly understood by one of ordinary skill in the art. The terminology used in the disclosure herein is for describing particular embodiments only and is not intended to be limiting.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used in the specification and the appended claims, the singular forms “a,” “an,” and “the” are intended to include the plural forms as well, unless the context clearly indicates otherwise. Thus, for example, reference to “a” component includes aspects having two or more such components, unless the context clearly indicates otherwise.

The term “1,4-polybutadiene,” as described herein, refers to the polymer prior to blending with other rubber additives to produce rubber compositions used in tire and non-tire applications.

The terms “1,4-polybutadiene rubber composition” or “rubber composition,” as described herein, refers to the polymer (e.g., 1,4-polybutadiene) and the additional fillers and additives blended therewith for use in tire and non-tire applications.

The term “cis content,” as described herein, refers to the percentage of cis-1,4 linkages in the 1,4-polybutadiene.

The term, “high-cis,” as described herein refers to a cis content of 50% or greater of the 1,4-polybutadiene.

The term “vinyl content,” as described herein, refers to the percentage of vinyl-1,2 linkages in the 1,4-polybutadiene.

The term “trans content,” as described herein, refers to the percentage of trans-1,4 linkages in the 1,4-polybutadiene.

“Number average molecular weight Mn” and “weight average molecular weight Mw,” as described herein, are determined by gel permeation chromatography.

“Cis content,” “vinyl content,” “trans content,” and “degree of hydrogenation,” as described herein, are determined by ¹H-Nuclear Magnetic Resonance spectroscopy in tetrachloroethane-d2 at 80° C.

“Degree of hydrogenation,” as described herein, refers to the percent of double bonds of the polymer broken by hydrogen added to the chain.

“Melting temperature Tₘ,” as described herein, refers to the peak maximum of the melting endotherm.

“Melting temperature Tₘ,” “Enthalpy of melting ΔHₘ,” and “glass transition temperature T_{g},” as described herein, are measured by differential scanning calorimetry, as described in more detail in the Examples section.

The term “phr,” as described herein, refers to parts by weight of the identified component per 100 parts rubber.

As used herein, the term “natural rubber” means naturally occurring rubber such as can be harvested from sources such as Hevea rubber trees and non-Hevea sources (e.g., guayule shrubs and dandelions such as TKS). In other words, the term “natural rubber” should be construed so as to exclude synthetic polyisoprene.

As used herein the term “polyisoprene” means synthetic polyisoprene. In other words, the term is used to indicate a polymer that is manufactured from isoprene monomers, and should not be construed as including naturally occurring rubber (e.g., Hevea natural rubber, guayule-sourced natural rubber, or dandelion-sourced natural rubber). However, the term polyisoprene should be construed as including polyisoprenes manufactured from natural sources of isoprene monomer.

As discussed hereinabove, high-cis 1,4-polybutadiene compositions may provide the desired mechanical properties, but may not be equally suited for both low and high temperature tire and non-tire applications. In particular, at lower temperatures of less than or equal to 0° C., these compositions are susceptible to crystallization. Crystallization may stiffen a tire at these lower temperatures, reducing traction during snowy and icy conditions. These compositions may possess crystallites having a peak melting temperature equal to or above 100° C.

Disclosed herein are rubber compositions which mitigate the aforementioned problems. Specifically, the rubber compositions disclosed herein include partially hydrogenated high-cis 1,4-polybutadiene. As stated above, crystallization of cis-1,4 butadiene units at low temperatures (e.g., less than or equal to 0° C.) is undesirable because it may harden the tire. Thus, reduced formation of crystallites formed from cis-1,4 butadiene units is desirable. High temperature melting crystallites (e.g., Tm2 of greater than or equal to 100° C. and less than or equal to 140° C.) are desirable because they impart improved tear and cut resistance. Reduced cis-1,4 butadiene unit crystallization at low temperatures and increased high temperature melting crystallites are achieved by the partially hydrogenated high-cis 1,4-polybutadiene disclosed herein.

The partially hydrogenated 1,4-polybutadiene disclosed herein has a cis content of about 50% to about 96%, a vinyl content of about 0% to about 1%, and a trans content of about 1% to about 10%.

In embodiments, the partially hydrogenated 1,4-polybutadiene may be a partially hydrogenated high-cis 1,4-polybutadiene. In embodiments, the partially hydrogenated 1,4-polybutadiene may have a cis content greater than or equal to about 50%, greater than or equal to about 55%, greater than or equal to about 60%, or even greater than or equal to about 65%. In embodiments, the partially hydrogenated 1,4-polybutadiene may have a cis content less than or equal to about 96%, less than or equal to about 95%, less than or equal to 90%, less than or equal to 85%, or even less than or equal to 80%. In embodiments, the partially hydrogenated 1,4-polybutadiene may have a cis content from 50% to 96%, from 50% to 95%, from 50% to 90%, from 50% to 85%, from 50% to 80%, from 55% to 96%, from 55% to 95%, from 55% to 90%, from 55% to 85%, from 55% to 80%, from 60% to 96%, from 60% to 95%, from 60% to 90%, from 60% to 85%, from 60% to 80%, from 65% to 96%, from 65% to 95%, from 65% to 90%, from 65% to 85%, or even from 65% to 80%, or any and all sub-ranges formed from any of these endpoints.

In embodiments, the partially hydrogenated 1,4-polybutadiene may have a vinyl content greater than or equal to about 0%, greater than or equal to about 0.1% or even greater than or equal to about 0.25%. In embodiments, the partially hydrogenated 1,4-polybutadiene may have a vinyl content less than or equal to about 1%, less than or equal to about 0.75%, or even less than or equal to about 0.25%. In embodiments, the partially hydrogenated 1,4-polybutadiene may have a vinyl content from about 0% to about 1%, from about 0% to about 0.75%, from about 0% to about 0.5%, from about 0.1% to about 1%, from about 0.1% to about 0.75%, from about 0.1% to about 0.5%, from about 0.25% to about 1%, from about 0.25% to about 0.75%, or even from about 0.25% to about 0.5%, or any and all sub-ranges formed from any of these endpoints.

In embodiments, the partially hydrogenated 1,4-polybutadiene may have a trans content greater than or equal to about 1%, greater than or equal to about 2%, greater than or equal to about 3%, or even greater than or equal to about 4%. In embodiments, the partially hydrogenated 1,4-polybutadiene may have a trans content less than or equal to about 10%, less than or equal to about 9%, or even less than or equal to about 8%. In embodiments, the partially hydrogenated 1,4-polybutadiene may have a trans content from about 1% to about 10%, from about 1% to about 9%, from about 1% to about 8%, from about 2% to about 10%, from about 2% to about 9%, from about 2% to about 8%, from about 3% to about 10%, from about 3% to about 9%, from about 3% to about 8%, from about 4% to about 10%, from about 4% to about 9%, or even from about 4% to about 8%, or any and all sub-ranges formed from any of these endpoints.

Without being bound by theory, it is believed that hydrogenation, even at relatively low degrees of hydrogenation (e.g., less than or equal to 10%), reduces crystallization of cis-1,4 butadiene units at lower temperatures, such as at less than or equal to 0° C. As a result, the present partially hydrogenated 1,4-polybutadiene rubber compositions provide improved low temperature performance, and thus, provide improved performance on ice or snow when incorporated into a winter tire tread compound.

Without being bound by theory, it is also believed that as the degree of hydrogenation increases (e.g., greater than 10%), formation of high temperature melting crystallites (e.g., Tₘ₂ of greater than or equal to 100° C. and less than or equal to 140° C.) occurs. As a result, the present partially hydrogenated 1,4-polybutadiene rubber compositions provide improved high temperature performance, and thus provide improved tear and cut resistance when incorporated into tire components such as sidewalls and treads.

The partially hydrogenated 1,4-polybutadiene disclosed herein may have a degree of hydrogenation of about 5% to about 50%. In embodiments, the partially hydrogenated 1,4-polybutadiene may have a degree of hydrogenation greater than or equal to about 5%, greater than or equal to about 10%, greater than or about 15%, greater than or equal to about 20%, greater than or equal to about 25%, or even greater than or equal to about 30%. In embodiments, the partially hydrogenated 1,4-polybutadiene may have a degree of hydrogenation less than or equal to about 50%, less than or equal to about 45%, or even less than or equal to about 40%. In embodiments, the partially hydrogenated 1,4-polybutadiene may have a degree of hydrogenation from about 5% to about 50%, from about 5% to about 45%, from about 5% to about 40%, from about 10% to about 50%, from about 10% to about 45%, from about 10% to about 40%, from about 15% to about 50%, from about 15% to about 45%, from about 15% to about 40%, from about 20% to about 50%, from about 20% to about 45%, from about 20% to about 40%, from about 25% to about 50%, from about 25% to about 45%, from about 25% to about 40%, or even about from about 30% to about 50%, from about 30% to about 45%, or even from about 30% to about 40%, or any and all sub-ranges formed from any of these endpoints.

The partially hydrogenated 1,4-polybutadiene disclosed herein may have a degree of hydrogenation of about 3% to about 50%. In embodiments, the partially hydrogenated 1,4-polybutadiene may have a degree of hydrogenation greater than or equal to about 3% or even greater than or equal to about 5% In embodiments, the partially hydrogenated 1,4-polybutadiene may have a degree of hydrogenation less than or equal to about 50%, less than or equal to about 40%, less than or equal to 30%, less than or equal to 20%, or even less than or equal to about 10%. In embodiments, the partially hydrogenated 1,4-polybutadiene may have a degree of hydrogenation from about 3% to about 50%, from about 3% to about 40%, from about 3% to about 30%, from about 3% to about 20%, from about 3% to about 10%, from about 5% to about 50%, from about 5% to about 40%, from about 5% to about 30%, from about 5% to about 20%, or even from about 5% to about 10%, or any and all sub-ranges formed from any of these endpoints. In embodiments, relatively lower hydrogenation (e.g., from about 3% to about 20%, or alternatively from about 3% to about 15%, or alternatively from about 3% to about 10%) may result in improved complex shear modulus (G*) at −30° C.) and Torque Lambourn abradibility.

Hydrogenation of the 1,4-polybutadiene may not effect the relatively low glass transition temperature T_{g} of the 1,4-polybutadiene (e.g., about −105° C.). A relatively low glass transition temperature T_{g} is indicative of wear resistance. In embodiments, the partially hydrogenated 1,4-polybutadiene may have a glass transition temperature T_{g} of about −115° C. to about −95° C. In embodiments, the partially hydrogenated 1,4-polybutadiene may have a glass transition temperature T_{g} greater than or equal to about −115° C., greater than or equal to about −113° C., greater than or equal to about −110° C., or even greater than or equal to about −107° C. In embodiments, the partially hydrogenated 1,4-polybutadiene may have a glass transition temperature T_{g} less than or equal to about −95° C., less than or equal to about −97° C., less than or equal to about −100° C., or even less than or equal to about −103° C. In embodiments, the partially hydrogenated 1,4-polybutadiene may have a glass transition temperature T_{g} from about −115° C. to about −95° C., from about −115° C. to about −97° C., from about −115° C. to about −100° C., from about −115° C. to about −103° C., from about −113° C. to about −95° C., from about −113° C. to about −97° C., from about −113° C. to about −100° C., from about −113° C. to about −103° C., from about −110° C. to about −95° C., from about −110° C. to about −97° C., from about −110° C. to about −100° C., from about −110° C. to about −103° C., from about −107° C. to about −95° C., from about −107° C. to about −97° C., from about −107° C. to about −100° C., or even from about −107° C. to about −103° C., or any and all sub-ranges formed from any of these endpoints.

In embodiments, the partially hydrogenated 1,4-polybutadiene may have a first melting temperature Tₘ₁ and a second melting temperature Tₘ₂. The first melting temperature Tₘ₁ corresponds to the melting temperature of crystallites derived from cis-1,4 segments of the partially hydrogenated 1,4-polybutadiene. The second melting temperature Tₘ₂ corresponds to the melting temperature of crystallites derived from the hydrogenated segments of the partially hydrogenated 1,4-polybutadiene.

In embodiments, the partially hydrogenated 1,4-polybutadiene may have a first melting temperature Tₘ₁ of about −30° C. to about 0° C. In embodiments, the partially hydrogenated 1,4-polybutadiene may have a first melting temperature Tₘ₁ greater than or equal to about −30° C., greater than or equal to about −25° C., or even greater than or equal to about −20° C. In embodiments, the partially hydrogenated 1,4-polybutadiene may have a first melting temperature Tₘ₁ less than or equal to 0° C., less than or equal to −5° C., or even less than or equal to −10° C. In embodiments, the partially hydrogenated 1,4-polybutadiene may have a first melting temperature Tₘ₁ from about −30° C. to about 0° C., from about −30° C. to about −5° C., from about −30° C. to about −10° C., from about −25° C. to about 0° C., from about −25° C. to about −5° C., from about −25° C. to about −10° C., from about −20° C. to about 0° C., from about −20° C. to about −5° C., or even from about −20° C. to about −10° C., or any and all sub-ranges formed from any of these endpoints.

In embodiments, the partially hydrogenated 1,4-polybutadiene may have a second melting temperature Tₘ₂ of about 100° C. to about 140° C. In embodiments, the partially hydrogenated 1,4-polybutadiene may have a second melting temperature Tₘ₂ greater than or equal to about 100° C., greater than or equal to about 105° C., or even greater than or equal to about 110° C. In embodiments, the partially hydrogenated 1,4-polybutadiene may have a second melting temperature Tₘ₂ less than or equal to 140° C., less than or equal to 125° C., or even less than or equal to 130° C. In embodiments, the partially hydrogenated 1,4-polybutadiene may have a second melting temperature Tₘ₂ from about 100° C. to about 140° C., from about 100° C. to about 135° C., from about 100° C. to about 130° C., from about 105° C. to about 140° C., from about 105° C. to about 135° C., from about 105° C. to about 130° C., from about 110° C. to about 140° C., from about 110° C. to about 135° C., or even from about 110° C. to about 130° C., or any and all sub-ranges formed from any of these endpoints.

As described hereinabove, partial hydrogenation of high cis 1,4-polybutadiene in rubber compositions provides resistance to the formation of crystallites that melt at low temperatures. Without being bound by theory, a lower enthalpy of melting (e.g., less than or equal to 50 J/g) of the partially hydrogenated 1,4-polybutadiene polymer at the first melting temperature Tₘ₁ (i.e., the melting temperature of crystallites derived from the cis-1,4 segments) is a characteristic that correlates to reduced cis-1,4 segment crystallization in tire applications. In embodiments, the hydrogenated 1,4-polybutadiene may have a first enthalpy of melting ΔHₘ₁ of about 3 J/g to about 50 J/g as measured at a temperature of about −30° C. to about 0° C. In further embodiments, the hydrogenated 1,4-polybutadiene may have a first enthalpy of melting ΔHₘ₁ greater than or equal to about 3 J/g, greater than or equal to about 5 J/g, greater than or equal to about 10 J/g, greater than or equal to about 15 J/g, or even greater than or equal to about 20 J/g as measured at a temperature of about −30° C. to about 0° C. In embodiments, the hydrogenated 1,4-polybutadiene may have a first enthalpy of melting ΔHₘ₁ less than or equal to about 50 J/g, less than or equal to about 45 J/g, or even less than or equal to about 40 J/g as measured at a temperature of about −30° C. to about 0° C. In embodiments, the hydrogenated 1,4-polybutadiene may have a first enthalpy of melting ΔHₘ₁ from about 3 J/g to about 50 J/g, from about 3 J/g to about 45 J/g, from about 5 J/g to about 40 J/g, from about 5 J/g to about 50 J/g, from about 5 J/g to about 45 J/g, from about 5 J/g to about 40 J/g, from about 10 J/g to about 50 J/g, from about 10 J/g to about 45 J/g, from about 10 J/g to about 40 J/g, from about 15 J/g to about 50 J/g, from about 15 J/g to about 45 J/g, from about 15 J/g to about 40 J/g, from about 20 J/g to about 50 J/g, from about 20 J/g to about 45 J/g, or even from about 20 J/g to about 40 J/g, or any and all sub-ranges formed from any of these endpoints, as measured at a temperature of about −30° C. to about 0° C.

In other embodiments, the hydrogenated 1,4-polybutadiene may have a first enthalpy of melting ΔHₘ₁ of about 0 J/g to about 45 J/g as measured at a temperature of about −30° C. to about 0° C. In further embodiments, the hydrogenated 1,4-polybutadiene may have a first enthalpy of melting ΔHₘ₁ greater than or equal to about 0 J/g, greater than or equal to about 3 J/g, greater than or equal to about 5 J/g, or even greater than or equal to about 10 J/g as measured at a temperature of about −30° C. to about 0° C. In embodiments, the hydrogenated 1,4-polybutadiene may have a first enthalpy of melting ΔHₘ₁ less than or equal to about 45 J/g, less than or equal to about 35 J/g, less than or equal to 25 J/g, or even less than or equal to 15 J/g as measured at a temperature of about −30° C. to about 0° C. In embodiments, the hydrogenated 1,4-polybutadiene may have a first enthalpy of melting ΔHₘ₁ from about 0 J/g to about 45 J/g, from about 0 J/g to about 35 J/g, from about 0 J/g to about 25 J/g, from about 0 J/g to about 15 J/g, from about 3 J/g to about 45 J/g, from about 3 J/g to about 35 J/g, from about 3 J/g to about 25 J/g, from about 3 J/g to about 15 J/g, from about 5 J/g to about 45 J/g, from about 5 J/g to about 35 J/g, from about 5 J/g to about 25 J/g, from about 5 J/g to about 15 J/g, from about 10 J/g to about 45 J/g, from about 10 J/g to about 35 J/g, from about 10 J/g to about 25 J/g, or even from about 10 J/g to about 15 J/g, or any and all sub-ranges formed from any of these endpoints, as measured at a temperature of about −30° C. to about 0° C.

As described hereinabove, the inclusion of hydrogenated 1,4-polybutadiene in rubber compositions provides the formation of crystallites that melt at high temperatures. As the degree of hydrogenation of 1,4-polybutadiene is increased, 1,4-butadiene segments are reduced and new saturated chain segments are generated. Without being bound by theory, a higher enthalpy of melting (e.g., greater than or equal to 0.5 J/g) of the partially hydrogenated 1,4-polybutadiene polymer at the second melting temperature Tₘ₂ (i.e., the melting temperature associated with hydrogenated segments) is a characteristic that correlates to increased crystallinity associated with hydrogenated segments. In embodiments, the partially hydrogenated 1,4-polybutadiene may have a second enthalpy of melting ΔHₘ₂ of about 0.5 J/g to about 20 J/g as measured at a temperature of up to about 140° C. In embodiments, the partially hydrogenated 1,4-polybutadiene may have a second enthalpy of melting ΔHₘ₂ greater than or equal to about 0.5 J/g, greater than or equal to about 1 J/g, greater than or equal to about 5 J/g, or even greater than or equal to 10 J/g as measured at a temperature of up to about 140° C. In embodiments, the partially hydrogenated 1,4-polybutadiene may have a second enthalpy of melting ΔHₘ₂ less than or equal to about 20 J/g, less than or equal to about 18 J/g, less than or equal to about 16 J/g, or even less than or equal to about 14 J/g as measured at a temperature of up to about 140° C. In embodiments, the partially hydrogenated 1,4-polybutadiene may have a second enthalpy of melting ΔHₘ₂ from about 0.5 J/g to about 20 J/g, from about 0.5 J/g to about 18 J/g, from about 0.5 J/g to about 16 J/g, from about 0.5 J/g to about 14 J/g, from about 1 J/g to about 20 J/g, from about 1 J/g to about 18 J/g, from about 1 J/g to about 16 J/g, from about 1 J/g to about 14 J/g, from about 5 J/g to about 20 J/g, from about 5 J/g to about 18 J/g, from about 5 J/g to about 16 J/g, from about 5 J/g to about 14 J/g, from about 10 J/g to about 20 J/g, from about 10 J/g to about 18 J/g, from about 10 J/g to about 16 J/g, or even from about 10 J/g to about 14 J/g, or any and all sub-ranges formed from any of these endpoints, as measured at a temperature of up to about 140° C.

In other embodiments, the partially hydrogenated 1,4-polybutadiene may have a second enthalpy of melting ΔHₘ₂ of about 0 J/g to about 20 J/g as measured at a temperature of up to about 140° C. In embodiments, the partially hydrogenated 1,4-polybutadiene may have a second enthalpy of melting ΔHₘ₂ greater than or equal to about 0 J/g, greater than or equal to about 0.1 J/g, greater than or equal to about 0.5 J/g, greater than or equal to about 1 J/g, greater than or equal to about 5 J/g, or even greater than or equal to 10 J/g as measured at a temperature of up to about 140° C. In embodiments, the partially hydrogenated 1,4-polybutadiene may have a second enthalpy of melting ΔHₘ₂ less than or equal to about 20 J/g, less than or equal to about 18 J/g, less than or equal to about 16 J/g, or even less than or equal to about 14 J/g as measured at a temperature of up to about 140° C. In embodiments, the partially hydrogenated 1,4-polybutadiene may have a second enthalpy of melting ΔHₘ₂ from about 0 J/g to about 20 J/g, from about 0 J/g to about 18 J/g, from about 0 J/g to about 16 J/g, from about 0 J/g to about 14 J/g, from about 0.1 J/g to about 20 J/g, from about 0.1 J/g to about 18 J/g, from about 0.1 J/g to about 16 J/g, from about 0.1 J/g to about 14 J/g, from about 0.5 J/g to about 20 J/g, from about 0.5 J/g to about 18 J/g, from about 0.5 J/g to about 16 J/g, from about 0.5 J/g to about 14 J/g, from about 1 J/g to about 20 J/g, from about 1 J/g to about 18 J/g, from about 1 J/g to about 16 J/g, from about 1 J/g to about 14 J/g, from about 5 J/g to about 20 J/g, from about 5 J/g to about 18 J/g, from about 5 J/g to about 16 J/g, from about 5 J/g to about 14 J/g, from about 10 J/g to about 20 J/g, from about 10 J/g to about 18 J/g, from about 10 J/g to about 16 J/g, or even from about 10 J/g to about 14 J/g, or any and all sub-ranges formed from any of these endpoints, as measured at a temperature of up about 140° C.

In embodiments, the partially hydrogenated 1,4-polybutadiene may have a weight average molecular weight M_{w} of about 100,000 g/mol to about 500,000 g/mol. In embodiments, the partially hydrogenated 1,4-polybutadiene may have a weight average molecular weight M_{w} greater than or equal to about 100,000 g/mol, greater than or equal to about 110,000 g/mol, or even greater than or equal to about 120,000 g/mol. In embodiments, the partially hydrogenated 1,4-polybutadiene may have a weight average molecular weight M_{w} less than or equal to about 500,000 g/mol, less than or equal to about 400,000 g/mol, less than or equal to about 300,000 g/mol, less than or equal to about 200,000 g/mol, or even less than or equal to about 160,000 g/mol. In embodiments, the hydrogenated 1,4-polybutadiene may have a weight average molecular weight M_{w} from about 100,000 g/mol to about 500,000 g/mol, from about 100,000 g/mol to about 400,000 g/mol, from about 100,000 g/mol to about 300,000 g/mol, from about 100,000 g/mol to about 200,000 g/mol, from about 100,000 g/mol to about 160,000 g/mol, from about 110,000 g/mol to about 500,000 g/mol, from about 110,000 g/mol to about 400,000 g/mol, from about 110,000 g/mol to about 300,000 g/mol, from about 110,000 g/mol to about 200,000 g/mol, from about 110,000 g/mol to about 160,000 g/mol, from about 120,000 g/mol to about 500,000 g/mol, from about 120,000 g/mol to about 400,000 g/mol, from about 120,000 g/mol to about 300,000 g/mol, from about 120,000 g/mol to about 200,000 g/mol, or even from about 120,000 g/mol to about 160,000 g/mol, or any and all sub-ranges formed from any of these endpoints.

In embodiments, the hydrogenated 1,4-polybutadiene may have a number average molecular weight Mn greater than or equal to about 20,000 g/mol, greater than or equal to about 40,000 g/mol, or even greater than or equal to about 60,000 g/mol. In embodiments, the hydrogenated 1,4-polybutadiene may have a number average molecular weight Mn less than or equal to about 250,000 g/mol, less than or equal to about 150,000 g/mol, less than or equal to about 100,000 g/mol, or even less than or equal to about 80,000 g/mol. In embodiments, the hydrogenated 1,4-polybutadiene may have a number average molecular weight Mn from about 20,000 g/mol to about 250,000 g/mol, from about 20,000 g/mol to about 150,000 g/mol, from about 20,000 g/mol to about 100,000 g/mol, from about 20,000 g/mol to about 80,000 g/mol, from about 40,000 g/mol to about 250,000 g/mol, from about 40,000 g/mol to about 150,000 g/mol, from about 40,000 g/mol to about 100,000 g/mol, from about 40,000 g/mol to about 80,000 g/mol, from about 60,000 g/mol to about 250,000 g/mol, from about 60,000 g/mol to about 150,000 g/mol, from about 60,000 g/mol to about 100,000 g/mol, or even from about 60,000 g/mol to about 80,000 g/mol, or any and all sub-ranges formed from any of these endpoints.

Certain embodiments for producing the polymer reacting the living end polymer chains with a functionalizing compound of formula (I). According to embodiments, the modified high-cis polybutadiene polymer includes polymer chains resulting from polymerization of 1,3-butadiene which are bonded to a residue of the functionalizing compound having formula (I), wherein each polymer chain is bonded to the residue of the functionalizing compound through the X group.

According to embodiments, formula (I) is as follows:

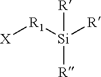

where X is a group reactive with the living end polymer chains and is selected from the group consisting of cyano, epoxy, ketone, aldehyde, ester, and acid anhydrides, each R₁ is selected from hydrocarbylene of C₁-C₂₀ (e.g., C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, or C₂₀), preferably C₁-C₁₀ (e.g., C₁, C₂, C₃, C₄, C₅, C₆, C₇, C₈, C₉, or C₁₀), more preferably C₁-C₃ (e.g., C₁, C₂, or C₃), wherein each of the foregoing optionally contain one unsaturated carbon-carbon bond, R′ is selected from alkoxy or carboxy of C₁-C₂₀ (e.g., C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, or C₂₀), preferably alkoxy or carboxy of C₁-C₁₀ (e.g., C₁, C₂, C₃, C₄, C₅, C₆, C₇, C₈, C₉, or C₁₀), more preferably alkoxy of C₁-C₆ (e.g., C₁, C₂, C₃, C₄, C₅, or C₆), most preferably alkoxy or carboxy of C₁ or C₂, and R″ is selected from alkyl, alkoxy, or carboxy of C₁-C₂₀ or aryl of C₆—C₂₀ (e.g., C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, or C₂₀), preferably alkyl, alkoxy, or carboxy of C₁-C₁₀ (e.g., C₁, C₂, C₃, C₄, C₅, C₆, C₇, C₈, C₉, or C₁₀), or aryl of C₆-C₁₄ (e.g., C₆, C₇, C₈, C₉, C₁₀, C₁₁, C₁₂, C₁₃, or C₁₄), more preferably alkyl, alkoxy, or carboxy of C₁-C₆ or aryl of C₆. Formula (I) can also be represented as: X—R₁—Si(R′)₂(R″). In certain embodiments, the functionalizing compound of formula (I) has a structure wherein R¹, R′ and R″ are all selected from the groups described as preferred. In other embodiments, the functionalizing compound of formula (I) has a structure wherein R¹, R′ and R″ are all selected from the groups described as preferred. Since the functionalizing compound of formula (I) has two alkoxy groups on the Si, the compound can be referred to a dialkoxysilane (more specifically an alkyldialkoxysilane or aryldialkoxysilane due to the presence of the R″ group). By stating that R¹ is a hydrocarbylene group is meant that that it is bonded to two other constituents (i.e., the X group and the Si). In certain preferred embodiments of the first-third embodiments, R¹ is aliphatic and unsaturated. In other embodiment, R¹ is aliphatic and can include one unsaturated carbon-carbon bond. Generally, according to embodiments, the carbons in the R¹ group can be positioned in a linear configuration or may be branched.

In some embodiments, X is a cyano group or an epoxy group, more preferably an epoxy group. According to embodiments, when X is a cyano group, its particular structure may vary, such as is discussed in more detail below. According to embodiments, when X is an epoxy group, it preferably has 2-4 carbon atoms (e.g., 2, 3, or 4 carbon atoms) in the epoxy ring.

As mentioned above, according to embodiments, the X of the functionalizing compound of formula (I) (or the residue resulting therefrom) is preferably selected from an epoxy group, more preferably the epoxy group is a glycidoxy group. Suitable compounds for use as the functionalizing compound of formula (I) wherein X is an epoxy group include, but are not limited to, (2-glycidoxyethyl)methyldimethoxysilane, (2-glycidoxyethyl)methyldiethoxysilane, (2-glycidoxyethyl)ethyldimethoxysilane, (2-glycidoxyethyl)ethyldiethoxysilane, (3-glycidoxypropyl)methyldimethoxysilane, (3-glycidoxypropyl)methyldiethoxysilane, (3-glycidoxypropyl)ethyldimethoxysilane, (3-glycidoxypropyl)ethyldiethoxysilane, 2-(3,4-epoxycydohexyl)ethyl(methyldimethoxy)silane, 2-(3,4-epoxycydohexyl)ethyl(methyldiethoxy)silane, 2-(3,4-epoxycyclohexyl)ethyl(ethyldimethoxy)silane, and 2-(3,4-epoxycyclohexyl)ethyl(ethyldiethoxy)silane. Among the foregoing, (3-glycidoxypropyl)methyldimethoxysilane and (3-glycidoxypropyl)methyldiethoxysilane are particularly preferred.

In other embodiments, suitable compounds for use as the functionalizing compound of formula (I) wherein X is an epoxy group include, but are not limited to, (2-glycidoxyethyl)trimethoxysilane, (2-glycidoxyethyl)triethoxysilane, (2-glycidoxyethyl)trimethoxysilane, (2-glycidoxyethyl)triethoxysilane, (3-glycidoxypropyl)trimethoxysilane, (3-glycidoxypropyl)triethoxysilane, (3-glycidoxypropyl)trimethoxysilane, (3-glycidoxypropyl)triethoxysilane, 2-(3,4-epoxycydohexyl)ethyl(trimethoxy)silane, 2-(3,4-epoxycydohexyl)ethyl(triethoxy)silane, 2-(3,4-epoxycyclohexyl)ethyl(trimethoxy)silane, and 2-(3,4-epoxycyclohexyl)ethyl(triethoxy)silane.

As mentioned above, according embodiments, the X of the functionalizing compound of formula (I) (or the residue resulting therefrom) is preferably selected from a cyano group. Non-limiting examples of suitable cyano groups that may be used as X in formula (I) according to certain embodiments include compounds where the cyano group and the Si are separated by a hydrocarbylene group having 1-10 carbons, preferably 3-8 carbons. Non-limiting examples of suitable cyano groups that may be used as X in formula (I) according to certain embodiments include 2-cyanoethylmethyldiethoxysilane and 3-cyanopropylmethyldiethoxysilane. In those embodiments, wherein the X of the functionalizing compound of formula (I) (or the residue resulting therefrom) is selected from a ketone group, various compounds may be suitable as the functionalizing compound.

In those embodiments wherein the X of the functionalizing compound of formula (I) (or the residue resulting therefrom) is selected from a ketone group, various compounds may be suitable as the functionalizing compound. A non-limiting example of such a compound is p-(methyldiethoxysilyl)acetophenone.

In those embodiments wherein the X of the functionalizing compound of formula (I) (or the residue resulting therefrom) is selected from an aldehyde group, various compounds may be suitable as the functionalizing compound. A non-limiting example of such a compound is (methyldiethoxysilyl)undecanal.

In those embodiments wherein the X of the functionalizing compound of formula (I) (or the residue resulting therefrom) is selected from an ester group, various compounds may be suitable as the functionalizing compound. Non-limiting examples of suitable such compounds include hydrocarbyloxysilane compounds having a carboxylic acid hydrocarbyl ester residue. Particular examples of such compounds include, but are not limited to, 3-methacryloyloxypropylmethyldiethoxysilane, 3-methacryloyloxypropylmethyldimethoxysilane, 3-methacryloyloxypropylethyldimethoxysilane, 3-methacryloyloxypropylethyldiethoxysilane, and 3-methacryloyloxypropylmethyldiisopropoxysilane. Among the foregoing, 3-methacryloyloxypropylmethyldimethoxysilane and 3-methacryloyloxypropylmethyldiethoxysilane are preferred.

In those embodiments wherein the X of the functionalizing compound of formula (I) (or the residue resulting therefrom) is selected from an acid anhydride group, various compounds may be suitable as the functionalizing compound. Non-limiting examples of suitable such compounds include hydrocarbyloxysilane compounds having a carboxylic anhydride residue. Particular examples of such compounds include, but are not limited to, 3-(methyldiethoxysilyl)propysuccinic anhydride and 3-(methyldimethoxysilyl)propylsuccinic anhydride. Among them, 3-(methyldiethoxysilyl)propylsuccnic anhydride is preferred.

According to embodiments, polymer chains (which result from polymerization of 1,3-butadiene using one of the defined catalyst systems) are bonded to a functionalizing compound through the X group. Since the structure of the functionalizing compound will change somewhat upon bonding of a polymer chain to the X group, the moiety to which the polymer chain is bonded is described as a residue of a functionalizing compound. Generally, one polymer chain will bond to the residue of the functionalizing compound through the X group of each molecule of functionalizing compound. However, depending upon the structure of the X group, it is possible for more than one polymer chain to bond to the residue of the functionalizing compound. The location upon the functionalizing compound where the polymer chain bonds according to the process of the first embodiment (i.e., using one of the defined catalyst systems) can be contrasted with the location upon the functionalizing compound where the polymer chain would bond if an anionic initiator (e.g., n-butyl lithium) was used to polymerize 1,3-butadiene. More specifically, if an anionic initiator was used, polymer chains may bond to the functionalizing compound via an alkoxy group on the Si (replacing the OR of an OR alkoxy group and bonding directly to the Si) as well as through the X group. When one of the defined catalyst systems is used to polymerize 1,3-butadiene and produce living end polymer chains, the polymer chain bonds (only) to the functionalizing compound through the X group. As a non-limiting example, when the X of the functionalizing compound is an epoxy group, a polymer chain would bond to one of the carbons alpha to the oxygen of the epoxy ring. More specifically, according to such a bonding reaction, one polymer chain would bond to one of the carbon atoms alpha to the oxygen of the epoxy ring and the bonding would cause ring opening with conversion of the oxygen atom to OH.

According to embodiments, the amount of functionalizing compound of formula (I) that is used to react with the living end polymer chains (i.e., according to the process of the first embodiment) or that is present in the modified high-cis polybutadiene polymer as a residue (i.e., according to the second and third embodiments) may vary. In certain embodiments, the functionalizing compound is used in a molar ratio of 100:1 to 0.5:1 (e.g., 100:1, 90:1, 80:1, 70:1, 60:1, 50:1, 40:1, 30:1, 20:1, 10:1, 8:1, 6:1, 4:1, 2:1, 1:1, 0.5:1), preferably 50:1 to 1:1 (e.g., 50:1, 40:1, 30:1, 20:1, 10:1, 8:1, 6:1, 4:1, 2:1, or 1:1), more preferably 30:1 to 2:1 (e.g., 30:1, 25:1, 20:1, 15:1, 10:1, 8:1, 6:1, 4:1, or 2:1), the molar ratio based upon the moles of functionalizing compound to moles of primary metal in the catalyst system (i.e., moles of lanthanide for a lanthanide-based catalyst system, moles of nickel for a nickel-based catalyst system, or moles of cobalt for a cobalt-based catalyst system).

Other embodiments for producing the polymer include reacting the living end polymer chains with functionalizing compounds including heterocyclic nitrile compounds, such as pyrazinecarbonitrile, as described in U.S. Pat. No. 8,314,189, which is incorporated herein by reference.

In one or more embodiments, suitable other functionalizing compounds include those compounds that contain groups that may react with the reactive polymers produced in accordance with this invention. Exemplary functionalizing compounds include ketones, quinones, aldehydes, amides, esters, isocyanates, isothiocyanates, epoxides, imines, aminoketones, aminothioketones, and acid anhydrides. Examples of these compounds are disclosed in U.S. Pat. Nos. 4,906,706, 4,990,573, 5,064,910, 5,567,784, 5,844,050, 6,838,526, 6,977,281, and 6,992,147; U.S. Pat. Publication Nos. 2006/0004131 A1, 2006/0025539 A1, 2006/0030677 A1, and 2004/0147694 A1; Japanese Patent Application Nos. 05-051406A, 05-059103A, 10-306113A, and 11-035633A; which are incorporated herein by reference. Other examples of functionalizing compounds include azine compounds as described in U.S. Ser. No. 11/640,711, hydrobenzamide compounds as disclosed in U.S. Ser. No. 11/710,713, nitro compounds as disclosed in U.S. Ser. No. 11/710,845, and protected oxime compounds as disclosed in U.S. Ser. No. 60/875,484, all of which are incorporated herein by reference.

In particular embodiments, the functionalizing compounds employed may be metal halides, metalloid halides, alkoxysilanes, metal carboxylates, hydrocarbylmetal carboxylates, hydrocarbylmetal ester-carboxylates, and metal alkoxides.

Exemplary metal halide compounds include tin tetrachloride, tin tetrabromide, tin tetraiodide, n-butyltin trichloride, phenyltin trichloride, di-n-butyltin dichloride, diphenyltin dichloride, tri-n-butyltin chloride, triphenyltin chloride, germanium tetrachloride, germanium tetrabromide, germanium tetraiodide, n-butylgermanium trichloride, di-n-butylgermanium dichloride, and tri-n-butylgermanium chloride.

Exemplary metalloid halide compounds include silicon tetrachloride, silicon tetrabromide, silicon tetraiodide, methyltrichlorosilane, phenyltrichlorosilane, dimethyldichlorosilane, diphenyldichlorosilane, boron trichloride, boron tribromide, boron triiodide, phosphorous trichloride, phosphorous tribromide, and phosphorus triiodide.

Exemplary metal carboxylate compounds include tin tetraacetate, tin bis(2-ethylhexanaote), and tin bis(neodecanoate).

Exemplary hydrocarbylmetal carboxylate compounds include triphenyltin 2-ethylhexanoate, tri-n-butyltin 2-ethylhexanoate, tri-n-butyltin neodecanoate, triisobutyltin 2-ethylhexanoate, diphenyltin bis(2-ethylhexanoate), di-n-butyltin bis(2-ethylhexanoate), di-n-butyltin bis(neodecanoate), phenyltin tris(2-ethylhexanoate), and n-butylltin tris(2-ethylhexanoate).

Exemplary hydrocarbylmetal ester-carboxylate compounds include di-n-butyltin bis(n-octylmaleate), di-n-octyltin bis(n-octylmaleate), diphenyltin bis(n-octylmaleate), di-n-butyltin bis(2-ethylhexylmaleate), di-n-octyltin bis(2-ethylhexylmaleate), and diphenyltin bis(2-ethylhexylmaleate).

Exemplary metal alkoxide compounds include dimethoxytin, diethoxytin, tetraethoxytin, tetra-n-propoxytin, tetraisopropoxytin, tetra-n-butoxytin, tetraisobutoxytin, tetra-t-butoxytin, and tetraphenoxytin.

As stated previously, the rubber compositions disclosed herein may comprise the hydrogenated 1,4-polybutadiene polymer, and various other components and fillers discussed herein, for example reinforcing fillers and curatives. The fillers that may be employed may include those fillers that are conventionally employed in the manufacture of tires. Useful fillers include inorganic and organic fillers. In embodiments, the organic fillers may include carbon black and starch. In embodiments, the inorganic fillers may comprise silica, aluminum hydroxide, magnesium hydroxide, clays (hydrated aluminum silicates), or combinations thereof. In embodiments, the reinforcing filler may comprise carbon black, silica, or combinations thereof. In embodiments, the curative may comprise sulfur or sulfur donors.

In embodiments, the carbon black may comprise fast extrusion furnace black, semi-reinforcing furnace black, high abrasion furnace black, intermediate super abrasion furnace black, super abrasion furnace black, and the like. In embodiments, the amount of carbon black in the rubber composition may be from about 1 phr to about 60 phr. In embodiments, the amount of carbon black in the rubber composition may be greater than or equal to about 1 phr, greater than or equal to about 5 phr, greater than or equal to about 10 phr, or even greater than or equal to about about 20 phr. In embodiments, the amount of carbon black in the rubber composition may be less than or equal to about 60 phr, less than or equal to about 50 phr, less than or equal to about 40 phr, or even less than or equal to about 30 phr. In embodiments, the amount of carbon black in the rubber composition may be from about 1 phr to about 60 phr, from about 1 phr to about 60 phr, from about 1 phr to about 50 phr, from about 1 phr to about 40 phr, from about 1 phr to about 30 phr, from about 5 phr to about 60 phr, from about 5 phr to about 50 phr, from about 5 phr to about 40 phr, from about 5 phr to about 30 phr, from about 10 phr to about 60 phr, from about 10 phr to about 50 phr, from about 10 phr to about 40 phr, from about 10 phr to about 30 phr, from about 20 phr to about 60 phr, from about 20 phr to about 50 phr, from about 20 phr to about 40 phr, or even from about 20 phr to about 30 phr, or any and all sub-ranges formed from any of these endpoints.

In embodiments, the silica may comprise silicon compounds such as wet silica (hydrated silicic acid), dry silica (anhydrous silicic acid), calcium silicate, aluminum silicate, or a combination thereof. In embodiments, the amount of silica in the rubber composition may be from about 25 phr to about 150 phr. In embodiments, the amount of silica in the rubber composition may be greater than or equal to about 25 phr, greater than or equal to about 50 phr, or even greater than or equal to about 75 phr. In embodiments, the amount of silica in the rubber composition may be less than or equal to about 150 phr, less than or equal to about 125 phr, or even less than or equal to about 100 phr In embodiments, the amount of silica in the rubber composition may be from about 25 phr to about 150 phr, from about 25 phr to about 150 phr, from about 25 phr to about 125 phr, from about 25 phr to about 100 phr, from about 50 phr to about 150 phr, from about 50 phr to about 125 phr, from about 50 phr to about 100 phr, from about 75 phr to about 150 phr, from about 75 phr to about 125 phr, or even from about 75 phr to about 100 phr, or any and all sub-ranges formed from any of these endpoints.

In embodiments, the amount of silane in the rubber composition may be from about 1 phr to about 20 phr. In embodiments, the amount of silane in the rubber composition may be greater than or equal to about 1 phr, greater than or equal to about 3 phr, greater than or equal to about 5 phr, greater than or equal to about 7 phr, greater than or equal to about 9 phr, or even greater than or equal to about 11 phr. In embodiments, the amount of silane in the rubber composition may be less than or equal to about 20 phr, less than or equal to about 18 phr, less than or equal to about 16 phr, less than or equal to about 14 phr, less than or equal to about 12 phr, or even less than or equal to about 10 phr. In embodiments, the amount of silane in the rubber composition may be from about 1 phr to about 20 phr, from about 1 phr to about 18 phr, from about 1 phr to about 16 phr, from about 1 phr to about 14 phr, from about 1 phr to about 12 phr, from about 1 phr to about 10 phr, from about 1 phr to about 8 phr, from about 1 phr to about 6 phr, from about 1 phr to about 4 phr, from about 1 phr to about 2 phr, from about 3 phr to about 20 phr, from about 3 phr to about 18 phr, from about 3 phr to about 16 phr, from about 3 phr to about 14 phr, from about 3 phr to about 12 phr, from about 3 phr to about 10 phr, from about 3 phr to about 9 phr, from about 3 phr to about 7 phr, from about 3 phr to about 5 phr, from about 5 phr to about 15 phr, from about 5 phr to about 12 phr, from about 5 phr to about 9 phr, or even from about 5 phr to about 7 phr, or any and all sub-ranges formed from any of these endpoints.

In embodiments, in addition to the hydrogenated 1,4-polybutadiene, the rubber composition may comprise natural rubber or other rubbery elastomers, for example, synthetic rubbers such as polybutadiene, polyisoprene, polyisobutylene-co-isoprene, neoprene, poly(ethylene-co-propylene), poly(styrene-co-butadiene), poly(styrene-co-isoprene), and poly(styrene-co-isoprene-co-butadiene), poly(isoprene-co-butadiene), poly(ethylene-co-propylene-co-diene), polysulfide rubber, acrylic rubber, urethane rubber, silicone rubber, epichlorohydrin rubber, or combinations thereof.

The rubbery elastomer is exclusive of the hydrogendated 1,4-polybutadiene. The total rubber content includes the hydrogenated 1,4-polybutadiene and the rubbery elastomer, when included.

In embodiments, the amount of rubbery elastomer in the rubber composition may be from about 1 phr to about 90 phr. In embodiments, the amount of rubber elastomer in the rubber composition may be greater than or equal to about 0 phr, greater than or equal to about 1 phr, greater than or equal to about 15 phr, greater than or equal to about 30 phr, greater than or equal to about 45 phr, or even greater than or equal to about 60 phr. In embodiments, the amount of rubbery elastomer in the rubber composition may be less than or equal to about 90 phr, less than or equal to about 75 phr, less than or equal to about 60 phr, less than or equal to about 45 phr, or even less than or equal to about 30 phr. In embodiments, the amount of rubbery elastomer in the rubber composition may be from about 0 phr to about 90 phr, from about 0 phr to about 75 phr, from about 0 phr to about 60 phr, from about 0 phr to about 45 phr, from about 0 phr to about 30 phr, from about 0 phr to about 15 phr, from about 1 phr to about 90 phr, from about 1 phr to about 75 phr, from about 1 phr to about 60 phr, from about 1 phr to about 45 phr, from about 1 phr to about 30 phr, from about 1 phr to about 15 phr, from about 15 phr to about 90 phr, from about 15 phr to about 75 phr, from about 15 phr to about 60 phr, from about 15 phr to about 45 phr, from about 15 phr to about 30 phr, from about 30 phr to about 90 phr, from about 30 phr to about 75 phr, from about 30 phr to about 60 phr, from about 30 phr to about 45 phr, from about 45 phr to about 90 phr, from about 45 phr to about 75 phr, from about 45 phr to about 60 phr, from about 60 phr to about 90 phr, or even from about 60 phr to about 75 phr, or any and all sub-ranges formed from any of these endpoints.

In embodiments, useful processing or extender oils may also be included. In embodiments, oils may include those that are commercially available as paraffinic, aromatic, or naphthenic oils. In embodiments, the major constituent of the oil may be paraffinic. In embodiments, the extender oil may be oil extended sulfur. The tire components may also include other additives such as anti-ozonants, waxes, scorch inhibiting agents, processing aids, zinc oxide, tackifying resins, reinforcing resins, fatty acids such as stearic acid, peptizers, and one or accelerators.

In embodiments, the rubber composition may include a plasticizing component comprising about 0 to about 50 phr (e.g., about 0, about 5, about 10, about 15, about 20, about 25, about 30, about 35, about 40, about 45, or about 50 phr) of at least one plasticizing oil and about 0 to about 60 phr (e.g., about 0, about 5, about 10, about 15, about 20, about 25, about 30, about 35, about 40, about 45, about 50, about 55, or about 60 phr) of at least one hydrocarbon resin having a Tg of at least 30° C. In some embodiments, at least one of the plasticizing oil or hydrocarbon resin is present in the rubber composition. In embodiments, the plasticizing component may include about 0 to about 30 phr of plasticizing oil and about 5 to about 60 phr of hydrocarbon resin. In some embodiments, the plasticizing component may include about 0 to about 15 phr of plasticizing oil and about 5 to about 50 phr of hydrocarbon resin. In certain embodiments, plasticizing oil may be present in an amount of at least about 1 phr (e.g., about 1-50 phr, about 1-30 phr, about 1-15 phr, about 1-10 phr, about 1-5 phr, etc.).

Various types of plasticizing oils may be utilized, including, but not limited to aromatic, naphthenic, and low PCA oils. In embodiments, the plasticizing oil is a liquid (pourable) at 25° C. Suitable low PCA oils include those having a polycyclic aromatic content of less than 3 percent by weight as determined by the IP346 method. Procedures for the IP346 method may be found in Standard Methods for Analysis & Testing of Petroleum and Related Products and British Standard 2000 Parts, 2003, 62nd edition, published by the Institute of Petroleum, United Kingdom. Suitable low PCA oils include mild extraction solvates (MES), treated distillate aromatic extracts (TDAE), TRAE, and heavy naphthenics. Suitable MES oils are available commercially as CATENEX SNR from SHELL, PROREX 15, and FLEXON 683 from EXXONMOBIL, VIVATEC 200 from BP, PLAXOLENE MS from TOTAL FINA ELF, TUDALEN 4160/4225 from DAHLEKE, MES-H from REPSOL, MES from Z8, and OLIO MES S201 from AGIP. Suitable TDAE oils are available as TYREX 20 from EXXONMOBIL, VIVATEC 500, VIVATEC 180, and ENERTHENE 1849 from BP, and EXTENSOIL 1996 from REPSOL. Suitable heavy naphthenic oils are available as SHELLFLEX 794, ERGON BLACK OIL, ERGON H2000, CROSS C2000, CROSS C2400, and SAN JOAQUIN 2000L. Suitable low PCA oils also include various plant-sourced oils such as can be harvested from vegetables, nuts, and seeds. Non-limiting examples include, but are not limited to, soy or soybean oil, sunflower oil (including high oleic sunflower oil having an oleic acid content of at least 60%, at least 70% or at least 80%), safflower oil, corn oil, linseed oil, cotton seed oil, rapeseed oil, cashew oil, sesame oil, camellia oil, jojoba oil, macadamia nut oil, coconut oil, and palm oil. In certain embodiments, the tire rubber composition includes only a limited amount of oil such as less than about 10 phr (e.g., about 9, about 8, about 7, about 6, about 5, about 4, about 3, about 2, about 1, or about 0 phr), less than about 5 phr, about 1 to about 5 phr, or even about 0 phr.

Various types of hydrocarbon resins may be utilized in the plasticizing component, including plasticizing resins. As used herein, the term plasticizing resin refers to a compound that is solid at room temperature (23° C.) and is miscible in the rubber composition at the amount used which is usually at least 5 phr. Generally, the plasticizing resin will act as a diluting agent and can be contrasted with tackifying resins which are generally immiscible and may migrate to the surface of a rubber composition providing tack. In certain embodiments of the third embodiment, wherein a plasticizing resin is utilized, it comprises a hydrocarbon resin and may be aliphatic type, aromatic type or aliphatic/aromatic type depending on the monomers contained therein. Examples of suitable plasticizing resins for use in the rubber compositions of the third embodiment include, but are not limited to, cyclopentadiene (abbreviated to CPD) or dicyclopentadiene (abbreviated to DCPD) homopolymer or copolymer resins, terpene homopolymer or copolymer resins and C5 fraction homopolymer or copolymer resins. Such resins may be used, for example, individually or in combination. In certain embodiments, a plasticizing resin is used which meets at least one of the following: a Tg greater than 30° C. (preferably greater than 40° C. and/or no more than 120° C. or no more than 100° C.), a number average molecular weight (Mn) of between 400 and 2000 grams/mole (preferably 500-2000 grams/mole), and a polydispersity index (PI) of less than 3 (preferably less than 2), wherein PI=Mw/Mn and Mw is the weight-average molecular weight of the resin. Tg of the resin can be measured by DSC (Differential Scanning Calorimetry) according to ASTM D3418 (1999). M_{w}, Mn and PI of the resin may be determined by size exclusion chromatography (SEC), using THF, 35° C.; concentration 1 g/1; flow rate 1 milliliters/min; solution filtered through a filter with a porosity of 0.45 pm before injection; Moore calibration with polystyrene standards; set of 3 “Waters” columns in series (“Styragel” HR4E, HR1 and HR0.5); detection by differential refractometer (“Waters 2410”) and its associated operating software (“Waters Empower”).

The anti-ozonants may comprise N,N′-disubstituted-p-phenylenediamines, such as N-1,3-dimethylbutyl-N′-phenyl-p-phenylenediamine, N,N′-Bis(1,4-dimethylpentyl)-p-phenylenediamine, N-phenyl-N-isopropyl-p-phenylenediamine (IPPD), and N-phenyl-N′-(1,3-dimethylbutyl)-p-phenylenediamine. Other examples of anti-ozonants include, Acetone diphenylamine condensation product, 2,4-Trimethyl-1,2-dihydroquinoline, Octylated Diphenylamine, and 2,6-di-t-butyl-4-methyl phenol.

The curing accelerators may include, but are not limited to, dithiocarbamate accelerators, including the metal dialkyldithiocarbamates such as, for example, zinc dibutyldithiocarbamate, zinc diethyldithiocarbamate, zinc dimethyldithiocarbamate, and ferric dimethyldithiocarbamate; thiazole accelerators including 2-mercaptobenzothiazole, the benzothiazole disulfides such as, for example, mercaptobenzothiazole disulfide; the benzothiazole sulfenamides, such as, for example, n-cyclohexyl-2-benzothiazole sulfenamide; and sulfenamide accelerators such as, for example, t-butyl-2-benzothiazyl sulfenamide. Moreover, the curing accelerators may also include diphenylguanidine.

Various amounts of the partially hydrogenated 1,4-polybutadiene are contemplated within the rubber composition. In embodiments, of the total hundred parts rubber, the partially hydrogenated 1,4-polybutadiene may include from about 10 to about 100 parts of the 100 total, or about 25 to about 75 parts of the 100 total. In embodiments, the amount of partially hydrogenated 1,4-polybutadiene in the rubber composition may be greater than or equal to about 10 phr, greater than or equal to about 15 phr, greater than or equal to about 20 phr, greater than or equal to about 25 phr, greater than or equal to about 30 phr, greater than or equal to about 35 phr, or even greater than or equal to about 40 phr. In embodiments, the amount of partially hydrogenated 1,4-polybutadiene in the rubber composition may be less than or equal to about 100 phr, less than or equal to about 90 phr, less than or equal to about 75 phr, or even less than or equal to 60 phr. In embodiments, the amount of partially hydrogenated 1,4-polybutadiene in the rubber composition may be from about 10 phr to about 100 phr, from about 10 phr to about 90 phr, from about 10 phr to about 75 phr, from about 10 phr to about 60 phr, from about 10 phr to about 50 phr, from about 15 phr to about 100 phr, from about 15 phr to about 90 phr, from about 15 phr to about 75 phr, from about 15 phr to about 60 phr, from about 15 phr to about 50 phr, from about 20 phr to about 100 phr, from about 20 phr to about 90 phr, from about 20 phr to about 75 phr, from about 20 phr to about 60 phr, from about 20 phr to about 50 phr, from about 25 phr to about 100 phr, from about 25 phr to about 90 phr, from about 25 phr to about 75 phr, from about 25 phr to about 60 phr, from about 25 phr to about 50 phr, from about 30 phr to about 100 phr, from about 30 phr to about 90 phr, from about 30 phr to about 80 phr, from about 30 phr to about 70 phr, from about 30 phr to about 60 phr, from about 30 phr to about 50 phr, from about 35 phr to about 100 phr, from about 35 phr to about 90 phr, from about 35 phr to about 80 phr, from about 35 phr to about 70 phr, from about 35 phr to about 60 phr, from about 35 phr to about 50 phr, from about 40 phr to about 100 phr, from about 40 phr to about 90 phr, from about 40 phr to about 75 phr, from about 40 phr to about 60 phr, or even from about 40 phr to about 50 phr, or any and all sub-ranges formed from any of these endpoints.

In embodiments, the 1,4-polybutadiene, prior to hydrogenation, may have a cis content of about 94% to about 99.5%, a vinyl content of about 0.1% to about 1%, and a trans content of about 0.1% to about 5%.

In embodiments, the 1,4-polybutadiene, prior to hydrogenation, may have a cis content greater than or equal to about 94%, greater than or equal to about 94.5%, greater than or equal to about 95%, greater than or equal to about 95.5%, or even greater than or equal to about 96%. In embodiments, the 1,4-polybutadiene, prior to hydrogenation, may have a cis content less than or equal to about 99.5%, less than or equal to about 99%, less than or equal to about 98.5%, or even less than or equal to about 95%. In embodiments, the 1,4-polybutadiene, prior to hydrogenation, may have a cis content from about 94% to about 99.5%, from about 94% to about 99%, from about 94% to about 98.5%, from about 94% to about 98%, from about 94.5% to about 99.5%, from about 94.5% to about 99%, from about 94.5% to about 98.5%, from about 94.5% to about 98%, from about 95% to about 99.5%, from about 95% to about 99%, from about 95% to about 98.5%, from about 95% to about 98%, from about 95.5% to about 99.5%, from about 95.5% to about 99%, from about 95.5% to about 98.5%, from about 95.5% to about 98%, from about 96% to about 99.5%, from about 96% to about 99%, from about 96% to about 98.5%, or even from about 96% to about 98%, or any and all sub-ranges formed from any of these endpoints.

In embodiments, the 1,4-polybutadiene, prior to hydrogenation, may have a vinyl content greater than or equal to about 0.1% or even greater than or equal to about 0.25%. In embodiments, the 1,4-polybutadiene, prior to hydrogenation, may have a vinyl content less than or equal to about 1%, less than or equal to about 0.75%, or even less than or equal to about 0.25%. In embodiments, the 1,4-polybutadiene, prior to hydrogenation, may have a vinyl content from about 0.1% to about 1%, from about 0.1% to about 0.75%, from about 0.1% to about 0.5%, from about 0.25% to about 1%, from about 0.25% to about 0.75%, or even from about 0.25% to about 0.5%, or any and all sub-ranges formed from any of these endpoints.

In embodiments, the 1,4-polybutadiene, prior to hydrogenation, may have a trans content greater than or equal to about 0.1%, greater than or equal to about 0.5%, greater than or equal to about 1%, greater than or equal to about 1.5%, greater than or equal to about 2%, greater than or equal to about 2.5%, or even greater than or equal to about 3%. In embodiments, the 1,4-polybutadiene, prior to hydrogenation, may have a trans content less than or equal to about 5%, less than or equal to about 4.5%, or even less than or equal to about 4%. In embodiments, the 1,4-polybutadiene, prior to hydrogenation, may have a trans content from about 0.1% to about 5%, from about 0.1% to about 4.5%, from about 0.1% to about 4%, from about 0.5% to about 5%, from about 0.5% to about 4.5%, from about 0.5% to about 4%, from about 1% to about 5%, from about 1% to about 4.5%, from about 1% to about 4%, from about 1.5% to about 5%, from about 1.5% to about 4.5%, from about 1.5% to about 4%, from about 2% to about 5%, from about 2% to about 4.5%, from about 2% to about 4%, from about 2.5% to about 5%, from about 2.5% to about 4.5%, from about 2.5% to about 4%, from about 3% to about 5%, from about 3% to about 4.5%, or even from about 3% to about 4%, or any and all sub-ranges formed from any of these endpoints.

Various polymerization methods are contemplated as suitable for making the 1,4-polybutadiene (i.e., prior to hydrogenation) of the present disclosure. In embodiments, the 1,4-polybutadiene may be prepared by coordination polymerization, wherein the monomers (for example, conjugated diene monomers) are polymerized by using a coordination catalyst system.

The conjugated diene monomer(s) used herein refers to monomer compositions having at least two double bonds that are separated by a single bond. The processes discussed herein may use at least one conjugated diene monomer containing less than 20 carbon atoms (i.e., 4 to 19 carbons). Examples of conjugated diene monomers include 1,3-butadiene, isoprene, 1,3-pentadiene, 1,3-hexadiene, 2,3-dimethyl-1,3-butadiene, 2-ethyl-1,3-butadiene, 2-methyl-1,3-pentadiene, 3-methyl-1,3-pentadiene, 4-methyl-1,3-pentadiene, and 2,4-hexadiene. Mixtures of two or more conjugated dienes may also be utilized in copolymerization. While all monomers are considered suitable, the present discussion will focus on the 1,3-butadiene monomer.

According to certain embodiments, the coordination catalyst system used for the polymerization of the 1,4-polybutadiene (i.e., prior to hydrogenation) is selected from one of (a) a lanthanide-based catalyst system or (b) a nickel or other transition metal based catalyst system. Preferably, a lanthanide-based catalyst system is used. Also preferably, the catalyst system that is used avoids the use of anionic initiator (e.g., an organolithium compound such as n-butyl lithium).

### Lanthanide-Based Catalyst System

As mentioned above, the process of one or more embodiments may utilize a lanthanide-based catalyst system which comprises: (i) a lanthanide compound, (ii) an alkylating agent, and (iii) a halogen source, where (iii) may optionally be provided by (i), (ii), or both (i) and (ii). The lanthanide-based catalyst system is used to polymerize a quantity of conjugated diene monomer (discussed in more detail below) to produce polymer chains with a living end. Preferably in certain embodiments, the lanthanide-based catalyst system is pre-formed before being added to any solution of the conjugated diene monomer.

As mentioned above, in certain embodiments the lanthanide-based catalyst system employed in the polymerization processes includes a lanthanide compound. Lanthanide compounds useful in these processes are those compounds that include at least one atom of a lanthanide element. As used herein, “lanthanide element” refers to the elements found in the lanthanide series of the Periodic Table (i.e., element numbers 57-71) as well as didymium, which is a mixture of rare-earth elements obtained from monazite sand. In particular, the lanthanide elements as disclosed herein include lanthanum, neodymium, cerium, praseodymium, promethium, samarium, europium, gadolinium, terbium, dysprosium, holmium, erbium, thulium, ytterbium, lutetium, and didymium. Preferably, the lanthanide compound includes at least one atom of neodymium, gadolinium, samarium, or combinations thereof. Most preferably, the lanthanide compound includes at least one atom of neodymium.

The lanthanide atom in the lanthanide compound can be in various oxidation states including, but not limited to, the 0, +2, +3, and +4 oxidation states. In accordance with certain preferred embodiments of the processes of the first embodiment, a trivalent lanthanide compound, where the lanthanide atom is in the +3 oxidation state, is used. Generally, suitable lanthanide compounds for use in the processes of the first embodiment include, but are not limited to, lanthanide carboxylates, lanthanide organophosphates, lanthanide organophosphonates, lanthanide organophosphinates, lanthanide carbamates, lanthanide dithiocarbamates, lanthanide xanthates, lanthanide diketonates, lanthanide alkoxides or aryloxides, lanthanide halides, lanthanide pseudo-halides, lanthanide oxyhalides, and organolanthanide compounds. Preferably, the lanthanide compound is a lanthanide carboxylate, more preferably a neodymium carboxylate and most preferably neodymium versatate.

In accordance with certain embodiments of the processes of the first embodiment, the lanthanide compound(s) may be soluble in hydrocarbon solvents such as the aromatic hydrocarbon solvents, aliphatic hydrocarbon solvents, or cycloaliphatic hydrocarbon solvents disclosed herein. Hydrocarbon-insoluble lanthanide compounds, however, can also be useful in the process of the first embodiment, as they can be suspended in the polymerization medium to form the catalytically active species.

For ease of illustration, further discussion of useful lanthanide compounds for use in the polymerization processes of certain embodiments will focus on neodymium compounds, although those skilled in the art will be able to select similar compounds that are based upon the other lanthanide metals disclosed herein.

Examples of suitable neodymium carboxylates for use as the lanthanide compound in the processes of the first embodiment include, but are not limited to, neodymium formate, neodymium acetate, neodymium acrylate, neodymium methacrylate, neodymium valerate, neodymium gluconate, neodymium citrate, neodymium fumarate, neodymium lactate, neodymium maleate, neodymium oxalate, neodymium 2-ethylhexanoate, neodymium neodecanoate (i.e., neodymium versatate or NdV3), neodymium naphthenate, neodymium stearate, neodymium oleate, neodymium benzoate, and neodymium picolinate.

Examples of suitable neodymium organophosphates for use as the lanthanide compound in the processes of the first embodiment include, but are not limited to, neodymium dibutyl phosphate, neodymium dipentyl phosphate, neodymium dihexyl phosphate, neodymium diheptyl phosphate, neodymium dioctyl phosphate, neodymium bis(1-methylheptyl)phosphate, neodymium bis(2-ethylhexyl)phosphate, neodymium didecyl phosphate, neodymium didodecyl phosphate, neodymium dioctadecyl phosphate, neodymium dioleyl phosphate, neodymium diphenyl phosphate, neodymium bis(p-nonylphenyl)phosphate, neodymium butyl (2-ethylhexyl)phosphate, neodymium (1-methylheptyl) (2-ethylhexyl)phosphate, and neodymium (2-ethylhexyl) (p-nonylphenyl)phosphate.

Examples of suitable neodymium organophosphonates for use as the lanthanide compound in processes of the first embodiment include, but are not limited to, neodymium butyl phosphonate, neodymium pentyl phosphonate, neodymium hexyl phosphonate, neodymium heptyl phosphonate, neodymium octyl phosphonate, neodymium (1-methylheptyl)phosphonate, neodymium (2-ethylhexyl)phosphonate, neodymium decyl phosphonate, neodymium dodecyl phosphonate, neodymium octadecyl phosphonate, neodymium oleyl phosphonate, neodymium phenyl phosphonate, neodymium (p-nonylphenyl)phosphonate, neodymium butyl butylphosphonate, neodymium pentyl pentylphosphonate, neodymium hexyl hexylphosphonate, neodymium heptyl heptylphosphonate, neodymium octyl octylphosphonate, neodymium (1-methylheptyl) (1-methylheptyl)phosphonate, neodymium (2-ethylhexyl) (2-ethylhexyl)phosphonate, neodymium decyl decylphosphonate, neodymium dodecyl dodecylphosphonate, neodymium octadecyl octadecylphosphonate, neodymium oleyl oleylphosphonate, neodymium phenyl phenylphosphonate, neodymium (p-nonylphenyl) (p-nonylphenyl)phosphonate, neodymium butyl (2-ethylhexyl)phosphonate, neodymium (2-ethylhexyl)butylphosphonate, neodymium (1-methylheptyl) (2-ethylhexyl)phosphonate, neodymium (2-ethylhexyl) (1-methylheptyl)phosphonate, neodymium (2-ethylhexyl) (p-nonylphenyl)phosphonate, and neodymium (p-nonylphenyl) (2-ethylhexyl)phosphonate.

Examples of suitable neodymium organophosphinates for use as the lanthanide compound in the processes of the first embodiment include, but are not limited to, neodymium butylphosphinate, neodymium pentylphosphinate, neodymium hexylphosphinate, neodymium heptylphosphinate, neodymium octylphosphinate, neodymium (1-methylheptyl)phosphinate, neodymium (2-ethylhexyl)phosphinate, neodymium decylphosphinate, neodymium dodecylphosphinate, neodymium octadecylphosphinate, neodymium oleylphosphinate, neodymium phenylphosphinate, neodymium (p-nonylphenyl)phosphinate, neodymium dibutylphosphinate, neodymium dipentylphosphinate, neodymium dihexylphosphinate, neodymium diheptylphosphinate, neodymium dioctylphosphinate, neodymium bis(1-methylheptyl)phosphinate, neodymium bis(2-ethylhexyl)phosphinate, neodymium didecylphosphinate, neodymium didodecylphosphinate, neodymium dioctadecylphosphinate, neodymium dioleylphosphinate, neodymium diphenylphosphinate, neodymium bis(p-nonylphenyl)phosphinate, neodymium butyl (2-ethylhexyl)phosphinate, neodymium (1-methylheptyl)(2-ethylhexyl)phosphinate, and neodymium (2-ethylhexyl)(p-nonylphenyl)phosphinate.

Examples of suitable neodymium carbamates for use as the lanthanide compound in the processes of the first embodiment include, but are not limited to, neodymium dimethylcarbamate, neodymium diethylcarbamate, neodymium diisopropylcarbamate, neodymium dibutylcarbamate, and neodymium dibenzylcarbamate.

Examples of suitable neodymium dithiocarbamates for use as the lanthanide compound in the processes of the first embodiment include, but are not limited to, neodymium dimethyldithiocarbamate, neodymium diethyldithiocarbamate, neodymium diisopropyldithiocarbamate, neodymium dibutyldithiocarbamate, and neodymium dibenzyldithiocarbamate.

Examples of suitable neodymium xanthates for use as the lanthanide compound in the processes of the first embodiment include, but are not limited to, neodymium methylxanthate, neodymium ethylxanthate, neodymium isopropylxanthate, neodymium butylxanthate, and neodymium benzylxanthate.

Examples of suitable neodymium diketonates for use as the lanthanide compound in the processes of the first embodiment include, but are not limited to, neodymium acetylacetonate, neodymium trifluoroacetylacetonate, neodymium hexafluoroacetylacetonate, neodymium benzoylacetonate, and neodymium 2,2,6,6-tetramethyl-3,5-heptanedionate.

Examples of suitable neodymium alkoxides or aryloxides for use as the lanthanide compound in the processes of the first embodiment include, but are not limited to, neodymium methoxide, neodymium ethoxide, neodymium isopropoxide, neodymium 2-ethylhexoxide, neodymium phenoxide, neodymium nonylphenoxide, and neodymium naphthoxide.

Examples of suitable neodymium halides for use as the lanthanide compound in the processes of the first embodiment include, but are not limited to, neodymium fluoride, neodymium chloride, neodymium bromide, and neodymium iodide. Suitable neodymium pseudo-halides include, but are not limited to, neodymium cyanide, neodymium cyanate, neodymium thiocyanate, neodymium azide, and neodymium ferrocyanide. Suitable neodymium oxyhalides include, but are not limited to, neodymium oxyfluoride, neodymium oxychloride, and neodymium oxybromide. A Lewis base, such as tetrahydrofuran (“THF”), can be employed as an aid for solubilizing this class of neodymium compounds in inert organic solvents. Where lanthanide halides, lanthanide oxyhalides, or other lanthanide compounds containing a halogen atom are used, the lanthanide compound may optionally also provide all or part of the halogen source in the lanthanide-based catalyst system.

As used herein, the term “organolanthanide compound” refers to any lanthanide compound containing at least one lanthanide-carbon bond. These compounds are predominantly, though not exclusively, those containing cyclopentadienyl (“Cp”), substituted cyclopentadienyl, allyl, and substituted allyl ligands. Suitable organolanthanide compounds for use as the lanthanide compound in the processes of the first embodiment include, but are not limited to, Cp3Ln, Cp2LnR, Cp2LnCl, CpLnCl2, CpLn(cyclooctatetraene), (C5Me5)2LnR, LnR3, Ln(allyl)3, and Ln(allyl)2Cl, where Ln represents a lanthanide atom, and R represents a hydrocarbyl group or a substituted hydrocarbyl group. In one or more embodiments, hydrocarbyl groups or substituted hydrocarbyl groups useful in the polymerization processes certain embodiments may contain heteroatoms such as, for example, nitrogen, oxygen, boron, silicon, sulfur, and phosphorus atoms.

As mentioned above, the lanthanide-based catalyst system employed in certain embodiments of the polymerization process includes an alkylating agent. In accordance with one or more embodiments of the polymerization process, alkylating agents, which may also be referred to as hydrocarbylating agents, include organometallic compounds that can transfer one or more hydrocarbyl groups to another metal. Generally, these agents include organometallic compounds of electropositive metals such as Groups 1, 2, and 3 metals (Groups IA, IIA, and IIIA metals). Alkylating agents useful certain embodiments of the polymerization process include, but are not limited to, organoaluminum and organomagnesium compounds. As used herein, the term “organoaluminum compound” refers to any aluminum-containing compound having at least one aluminum-carbon bond. In one or more embodiments, organoaluminum compounds that are soluble in a hydrocarbon solvent can be used. As used herein, the term “organomagnesium compound” refers to any magnesium-containing compound having at least one magnesium-carbon bond. In one or more embodiments, organomagnesium compounds that are soluble in a hydrocarbon can be used. As will be described in more detail below, certain suitable alkylating agents may be in the form of a halide compound. Where the alkylating agent includes a halogen atom, the alkylating agent may optionally also provide all or part of the halogen source in the lanthanide-based catalyst system.

In one or more embodiments, organoaluminum compounds that are utilized include those represented by the general formula AlRanX3-n, where each Ra independently is a monovalent organic group that is attached to the aluminum atom via a carbon atom; where each X independently is a hydrogen atom, a halogen atom, a carboxylate group, an alkoxide group, or an aryloxide group; and where n is an integer in the range of from 1 to 3. In one or more embodiments, each Ra independently is a hydrocarbyl group or a substituted hydrocarbyl group including, but not limited to, alkyl, cycloalkyl, substituted cycloalkyl, alkenyl, cycloalkenyl, substituted cycloalkenyl, aryl, substituted aryl, aralkyl, alkaryl, allyl, and alkynyl groups, with each group containing from 1 carbon atom, or the appropriate minimum number of atoms to form the group, up to 20 carbon atoms (e.g., 2, 3, 4, 5, 6, 7, 8, 9, 10, 11, 12, 13, 14, 15, 16, 17, 18, 19 or 20 carbon atoms). These hydrocarbyl groups or substituted hydrocarbyl groups may optionally contain heteroatoms including, but not limited to, nitrogen, oxygen, boron, silicon, sulfur, and phosphorus atoms.

Examples of types of organoaluminum compounds for use as the alkylating agent in the processes of the first embodiment that are represented by the general formula AlRanX3-n include, but are not limited to, trihydrocarbylaluminum, dihydrocarbylaluminum hydride, hydrocarbylaluminum dihydride, dihydrocarbylaluminum carboxylate, hydrocarbylaluminum bis(carboxylate), dihydrocarbylaluminum alkoxide, hydrocarbylaluminum dialkoxide, dihydrocarbylaluminum halide, hydrocarbylaluminum dihalide, dihydrocarbylaluminum aryloxide, and hydrocarbylaluminum diaryloxide compounds.

Examples of suitable trihydrocarbylaluminum compounds for use as the alkylating agent in the processes of the first embodiment include, but are not limited to, trimethylaluminum, triethylaluminum, triisobutylaluminum, tri-n-propylaluminum, triisopropylaluminum, tri-n-butylaluminum, tri-t-butylaluminum, tri-n-pentylaluminum, trineopentylaluminum, tri-n-hexylaluminum, tri-n-octylaluminum, tris(2-ethylhexyl)aluminum, tricyclohexylaluminum, tris (1-methylcyclopentyl)aluminum, triphenylaluminum, tri-p-tolylaluminum, tris(2,6-dimethylphenyl)aluminum, tribenzylaluminum, diethylphenylaluminum, diethyl-p-tolylaluminum, diethylbenzylaluminum, ethyldiphenylaluminum, ethyldi-p-tolylaluminum, and ethyldibenzylaluminum.

Examples of suitable dihydrocarbylaluminum hydride compounds for use as the alkylating agent in the processes of the first embodiment include, but are not limited to, diethylaluminum hydride, di-n-propylaluminum hydride, diisopropylaluminum hydride, di-n-butylaluminum hydride, diisobutylaluminum hydride, di-n-octylaluminum hydride, diphenylaluminum hydride, di-p-tolylaluminum hydride, dibenzylaluminum hydride, phenylethylaluminum hydride, phenyl-n-propylaluminum hydride, phenylisopropylaluminum hydride, phenyl-n-butylaluminum hydride, phenylisobutylaluminum hydride, phenyl-n-octylaluminum hydride, p-tolylethylaluminum hydride, p-tolyl-n-propylaluminum hydride, p-tolylisopropylaluminum hydride, p-tolyl-n-butylaluminum hydride, p-tolylisobutylaluminum hydride, p-tolyl-n-octylaluminum hydride, benzylethylaluminum hydride, benzyl-n-propylaluminum hydride, benzylisopropylaluminum hydride, benzyl-n-butylaluminum hydride, benzylisobutylaluminum hydride, and benzyl-n-octylaluminum hydride.

Examples of suitable hydrocarbylaluminum dihydrides for use as the alkylating agent in the processes include, but are not limited to, ethylaluminum dihydride, n-propylaluminum dihydride, isopropylaluminum dihydride, n-butylaluminum dihydride, isobutylaluminum dihydride, and n-octylaluminum dihydride.

Examples of suitable dihydrocarbylaluminum halide compounds for use as the alkylating agent in the processes of the first embodiment include, but are not limited to, diethylaluminum chloride, di-n-propylaluminum chloride, diisopropylaluminum chloride, di-n-butylaluminum chloride, diisobutylaluminum chloride, di-n-octylaluminum chloride, diphenylaluminum chloride, di-p-tolylaluminum chloride, dibenzylaluminum chloride, phenylethylaluminum chloride, phenyl-n-propylaluminum chloride, phenylisopropylaluminum chloride, phenyl-n-butylaluminum chloride, phenylisobutylaluminum chloride, phenyl-n-octylaluminum chloride, p-tolylethylaluminum chloride, p-tolyl-n-propylaluminum chloride, p-tolylisopropylaluminum chloride, p-tolyl-n-butylaluminum chloride, p-tolylisobutylaluminum chloride, p-tolyl-n-octylaluminum chloride, benzylethylaluminum chloride, benzyl-n-propylaluminum chloride, benzylisopropylaluminum chloride, benzyl-n-butylaluminum chloride, benzylisobutylaluminum chloride, and benzyl-n-octylaluminum chloride.

Examples of suitable hydrocarbylaluminum dihalide compounds for use as the alkylating agent in the processes of the first embodiment include, but are not limited to, ethylaluminum dichloride, n-propylaluminum dichloride, isopropylaluminum dichloride, n-butylaluminum dichloride, isobutylaluminum dichloride, and n-octylaluminum dichloride.

Examples of other suitable organoaluminum compounds for use as the alkylating agent in the processes of the first embodiment that are represented by the general formula AlRanX3-n include, but are not limited to, dimethylaluminum hexanoate, diethylaluminum octoate, diisobutylaluminum 2-ethylhexanoate, dimethylaluminum neodecanoate, diethylaluminum stearate, diisobutylaluminum oleate, methylaluminum bis(hexanoate), ethylaluminum bis(octoate), isobutylaluminum bis(2-ethylhexanoate), methylaluminum bis(neodecanoate), ethylaluminum bis(stearate), isobutylaluminum bis(oleate), dimethylaluminum methoxide, diethylaluminum methoxide, diisobutylaluminum methoxide, dimethylaluminum ethoxide, diethylaluminum ethoxide, diisobutylaluminum ethoxide, dimethylaluminum phenoxide, diethylaluminum phenoxide, diisobutylaluminum phenoxide, methylaluminum dimethoxide, ethylaluminum dimethoxide, isobutylaluminum dimethoxide, methylaluminum diethoxide, ethylaluminum diethoxide, isobutylaluminum diethoxide, methylaluminum diphenoxide, ethylaluminum diphenoxide, and isobutylaluminum diphenoxide.

Another class of organoaluminum compounds suitable for use as an alkylating agent in the processes of the first embodiment is aluminoxanes. Suitable aluminoxanes include oligomeric linear aluminoxanes, which can be represented by the general formula:

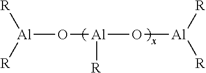

and oligomeric cyclic aluminoxanes, which can be represented by the general formula:

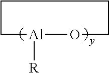

where x is an integer in the range of from 1 to 100 (e.g., 1, 10, 20, 30, 40, 50, 60, 70, 80, 90, or 100), or 10 to 50 (e.g., 10, 15, 20, 25, 30, 35, 40, 45, or 50); y is an integer in the range of from 2 to 100 (e.g., 2, 10, 20, 30, 40, 50, 60, 70, 80, 90 or 100), or 3 to 20 (e.g., 3, 5, 10, 15, or 20); and where each R independently is a monovalent organic group that is attached to the aluminum atom via a carbon atom. In certain embodiments, each R independently is a hydrocarbyl group or a substituted hydrocarbyl group including, but not limited to, alkyl, cycloalkyl, substituted cycloalkyl, alkenyl, cycloalkenyl, substituted cycloalkenyl, aryl, substituted aryl, aralkyl, alkaryl, allyl, and alkynyl groups, with each group preferably containing from 1 carbon atom, or the appropriate minimum number of atoms to form the group, up to 20 carbon atoms (e.g., 2, 3, 4, 5, 6, 7, 8, 9, 10, 11, 12, 13, 14, 15, 16, 17, 18, 19 or 20 carbon atoms). These hydrocarbyl groups or substituted hydrocarbyl groups may also contain heteroatoms including, but not limited to, nitrogen, oxygen, boron, silicon, sulfur, and phosphorus atoms. As used herein, the number of moles of the aluminoxane refers to the number of moles of the aluminum atoms rather than the number of moles of the oligomeric aluminoxane molecules. This convention is commonly employed in the art of catalyst systems utilizing aluminoxanes.

Aluminoxanes can be prepared by reacting trihydrocarbylaluminum compounds with water. This reaction can be performed according to known methods, such as, for example, (1) a method in which the trihydrocarbylaluminum compound is dissolved in an organic solvent and then contacted with water, (2) a method in which the trihydrocarbylaluminum compound is reacted with water of crystallization contained in, for example, metal salts, or water adsorbed in inorganic or organic compounds, or (3) a method in which the trihydrocarbylaluminum compound is reacted with water in the presence of the monomer or monomer solution that is to be polymerized.

Examples of suitable aluminoxane compounds for use as the alkylating agent in the processes of the first embodiment include, but are not limited to, methylaluminoxane (“MAO”), modified methylaluminoxane (“MMAO”), ethylaluminoxane, n-propylaluminoxane, isopropylaluminoxane, butylaluminoxane, isobutylaluminoxane, n-pentylaluminoxane, neopentylaluminoxane, n-hexylaluminoxane, n-octylaluminoxane, 2-ethylhexylaluminoxane, cyclohexylaluminoxane, 1-methylcyclopentylaluminoxane, phenylaluminoxane, and 2,6-dimethylphenylaluminoxane. In certain preferred embodiments of the processes of the first embodiment, the alkylating agent includes MAO. Modified methylaluminoxane can be formed by substituting from 20 to 80 percent of the methyl groups of methylaluminoxane with C₂ to C₁₂ hydrocarbyl groups (e.g., C₂, C₃, C₄, C₅, C₆, C₇, C₈, C₉, C₁₀, C₁₁ or C₁₂), preferably with isobutyl groups, by using techniques known to those skilled in the art.

In accordance with certain embodiments of the polymerization process, aluminoxanes can be used alone or in combination with other organoaluminum compounds. In one embodiment, methylaluminoxane and at least one organoaluminum compound other than aluminoxane, e.g., an organoaluminum compound represented by AlRanX3-n, are used in combination as the alkylating agent. In accordance with this and other embodiments, the alkylating agent comprises a dihydrocarbylaluminum hydride, a dihydrocarbylaluminum halide, an aluminoxane, or combinations thereof. For example, in accordance with one embodiment, the alkylating agent comprises diisobutylaluminum hydride, diethylaluminum chloride, methylaluminoxane, or combinations thereof. U.S. Pat. No. 8,017,695, which is incorporated herein by reference in its entirety, provides other examples where aluminoxanes and organoaluminum compounds can be employed in combination.

As mentioned above, suitable alkylating agents used in the processes of the first embodiment include organomagnesium compounds. In accordance with one or more embodiments, suitable organomagnesium compounds include those represented by the general formula MgRb2, where each Rb independently is a monovalent organic group that is attached to the magnesium atom via a carbon atom. In one or more embodiments, each Rb independently is a hydrocarbyl group or a substituted hydrocarbyl group including, but not limited to, alkyl, cycloalkyl, substituted cycloalkyl, alkenyl, cycloalkenyl, substituted cycloalkenyl, aryl, allyl, substituted aryl, aralkyl, alkaryl, and alkynyl groups, with each group preferably containing from 1 carbon atom, or the appropriate minimum number of atoms to form the group, up to 20 carbon atoms (e.g., 2, 3, 4, 5, 6, 7, 8, 9, 10, 11, 12, 13, 14, 15, 16, 17, 18, 19 or 20 carbon atoms). These hydrocarbyl groups or substituted hydrocarbyl groups may also optionally contain heteroatoms including, but not limited to, nitrogen, oxygen, silicon, sulfur, and phosphorus atoms.

Examples of suitable organomagnesium compounds for use as the alkylating agent in the processes of the first embodiment hat are represented by the general formula MgRb2 include, but are not limited to, diethylmagnesium, di-n-propylmagnesium, diisopropylmagnesium, dibutylmagnesium, dihexylmagnesium, diphenylmagnesium, and dibenzylmagnesium.

Another class of organomagnesium compounds suitable for use as an alkylating agent in accordance with certain embodiments of the polymerization process is represented by the general formula RcMgXc, where Rc is a monovalent organic group that is attached to the magnesium atom via a carbon atom, and X is a hydrogen atom, a halogen atom, a carboxylate group, an alkoxide group, or an aryloxide group. In one or more embodiments, Re is a hydrocarbyl group or a substituted hydrocarbyl group including, but not limited to, alkyl, cycloalkyl, substituted cycloalkyl, alkenyl, cycloalkenyl, substituted cycloalkenyl, aryl, allyl, substituted aryl, aralkyl, alkaryl, and alkynyl groups, with each group containing from 1 carbon atom, or the appropriate minimum number of atoms to form the group, up to 20 carbon atoms (e.g., 2, 3, 4, 5, 6, 7, 8, 9, 10, 11, 12, 13, 14, 15, 16, 17, 18, 19 or 20 carbon atoms). These hydrocarbyl groups or substituted hydrocarbyl groups may also contain heteroatoms including, but not limited to, nitrogen, oxygen, boron, silicon, sulfur, and phosphorus atoms. In one embodiment, Xc is a carboxylate group, an alkoxide group, or an aryloxide group, with each group containing from 1 carbon atom up to 20 carbon atoms (e.g., 2, 3, 4, 5, 6, 7, 8, 9, 10, 11, 12, 13, 14, 15, 16, 17, 18, 19 or 20 carbon atoms).

Examples of suitable types of organomagnesium compounds for use as the alkylating agent in certain embodiments are represented by the general formula RcMgXc include, but are not limited to, hydrocarbylmagnesium hydride, hydrocarbylmagnesium halide, hydrocarbylmagnesium carboxylate, hydrocarbylmagnesium alkoxide, and hydrocarbylmagnesium aryloxide.

Examples of suitable organomagnesium compounds for use as the alkylating agent in certain embodiments represented by the general formula RcMgXc include, but are not limited to, methylmagnesium hydride, ethylmagnesium hydride, butylmagnesium hydride, hexylmagnesium hydride, phenylmagnesium hydride, benzylmagnesium hydride, methylmagnesium chloride, ethylmagnesium chloride, butylmagnesium chloride, hexylmagnesium chloride, phenylmagnesium chloride, benzylmagnesium chloride, methylmagnesium bromide, ethylmagnesium bromide, butylmagnesium bromide, hexylmagnesium bromide, phenylmagnesium bromide, benzylmagnesium bromide, methylmagnesium hexanoate, ethylmagnesium hexanoate, butylmagnesium hexanoate, hexylmagnesium hexanoate, phenylmagnesium hexanoate, benzylmagnesium hexanoate, methylmagnesium ethoxide, ethylmagnesium ethoxide, butylmagnesium ethoxide, hexylmagnesium ethoxide, phenylmagnesium ethoxide, benzylmagnesium ethoxide, methylmagnesium phenoxide, ethylmagnesium phenoxide, butylmagnesium phenoxide, hexylmagnesium phenoxide, phenylmagnesium phenoxide, and benzylmagnesium phenoxide.

As mentioned above, the lanthanide-based catalyst systems employed in the polymerization processes of certain embodiment include a halogen source. As used herein, the term “halogen source” refers to any substance including at least one halogen atom. In accordance with one or more embodiments, all or part of the halogen source may optionally be provided by the lanthanide compound, the alkylating agent, or both the lanthanide compound and the alkylating agent. In other words, the lanthanide compound may serve as both the lanthanide compound and all or at least a portion of the halogen source. Similarly, the alkylating agent may serve as both the alkylating agent and all or at least a portion of the halogen source.

In accordance with certain embodiments, at least a portion of the halogen source may be present in the catalyst system in the form of a separate and distinct halogen-containing compound. Various compounds, or mixtures thereof, that contain one or more halogen atoms can be used as the halogen source. Examples of halogen atoms include, but are not limited to, fluorine, chlorine, bromine, and iodine. A combination of two or more halogen atoms can also be utilized. Halogen-containing compounds that are soluble in an organic solvent, such as the aromatic hydrocarbon, aliphatic hydrocarbon, and cycloaliphatic hydrocarbon solvents disclosed herein, are suitable for use as the halogen source in the processes of the first embodiment. In addition, hydrocarbon-insoluble halogen-containing compounds that can be suspended in a polymerization system to form the catalytically active species are also useful in certain embodiments of the processes of the first embodiment.

Examples of suitable types of halogen-containing compounds for use in the processes of the first embodiment include, but are not limited to, elemental halogens, mixed halogens, hydrogen halides, organic halides, inorganic halides, metallic halides, and organometallic halides. In certain preferred embodiments of the processes of the first embodiment, the halogen-containing compound includes an organometallic halide.

Examples of elemental halogens suitable for use as the halogen source in the processes of the first embodiment include, but are not limited to, fluorine, chlorine, bromine, and iodine. Some specific examples of suitable mixed halogens include, but are not limited to, iodine monochloride, iodine monobromide, iodine trichloride, and iodine pentafluoride.

Examples of suitable hydrogen halides for use as the halogen source in the processes disclosed include, but are not limited to, hydrogen fluoride, hydrogen chloride, hydrogen bromide, and hydrogen iodide.

Examples of suitable organic halides for use as the halogen source in the processes of the first embodiment include, but are not limited to, t-butyl chloride, t-butyl bromide, allyl chloride, allyl bromide, benzyl chloride, benzyl bromide, chloro-di-phenylmethane, bromo-di-phenylmethane, triphenylmethyl chloride, triphenylmethyl bromide, benzylidene chloride, benzylidene bromide, methyltrichlorosilane, phenyltrichlorosilane, dimethyldichlorosilane, diphenyldichlorosilane, trimethylchlorosilane, benzoyl chloride, benzoyl bromide, propionyl chloride, propionyl bromide, methyl chloroformate, and methyl bromoformate.

Examples of suitable inorganic halides for use as the halogen source in the processes of the first embodiment include, but are not limited to, phosphorus trichloride, phosphorus tribromide, phosphorus pentachloride, phosphorus oxychloride, phosphorus oxybromide, boron trifluoride, boron trichloride, boron tribromide, silicon tetrafluoride, silicon tetrachloride, silicon tetrabromide, silicon tetraiodide, arsenic trichloride, arsenic tribromide, arsenic triiodide, selenium tetrachloride, selenium tetrabromide, tellurium tetrachloride, tellurium tetrabromide, and tellurium tetraiodide.

Examples of suitable metallic halides for use as the halogen source in the processes of the first embodiment include, but are not limited to, tin tetrachloride, tin tetrabromide, aluminum trichloride, aluminum tribromide, antimony trichloride, antimony pentachloride, antimony tribromide, aluminum triiodide, aluminum trifluoride, gallium trichloride, gallium tribromide, gallium triiodide, gallium trifluoride, indium trichloride, indium tribromide, indium triiodide, indium trifluoride, titanium tetrachloride, titanium tetrabromide, titanium tetraiodide, zinc dichloride, zinc dibromide, zinc diiodide, and zinc difluoride.

Examples of suitable organometallic halides for use as the halogen source in the processes of the first embodiment include, but are not limited to, dimethylaluminum chloride, diethylaluminum chloride, dimethylaluminum bromide, diethylaluminum bromide, dimethylaluminum fluoride, diethylaluminum fluoride, methylaluminum dichloride, ethylaluminum dichloride, methylaluminum dibromide, ethylaluminum dibromide, methylaluminum difluoride, ethylaluminum difluoride, methylaluminum sesquichloride, ethylaluminum sesquichloride, isobutylaluminum sesquichloride, methylmagnesium chloride, methylmagnesium bromide, methylmagnesium iodide, ethylmagnesium chloride, ethylmagnesium bromide, butylmagnesium chloride, butylmagnesium bromide, phenylmagnesium chloride, phenylmagnesium bromide, benzylmagnesium chloride, trimethyltin chloride, trimethyltin bromide, triethyltin chloride, triethyltin bromide, di-t-butyltin dichloride, di-t-butyltin dibromide, dibutyltin dichloride, dibutyltin dibromide, tributyltin chloride, and tributyltin bromide. In accordance with one embodiment, the halogen source comprises an organometallic halide. For example, in accordance with certain embodiments, the halogen source comprises diethylaluminum chloride, which as mentioned above can also serve as an alkylating agent in the lanthanide-based catalyst system. Thus, in accordance with certain embodiments of the polymerization process, the halogen source may be provided in all or in part by the alkylating agent in the catalyst systems disclosed herein.

The lanthanide-based catalyst system used in certain embodiments of the polymerization process may be formed by combining or mixing the foregoing catalyst ingredients. The terms “catalyst composition” and “catalyst system,” as referred to herein, encompass a simple mixture of the ingredients, a complex of the various ingredients that is caused by physical or chemical forces of attraction, a chemical reaction product of the ingredients, or a combination of the foregoing. The terms “catalyst composition” and “catalyst system” can be used interchangeably herein.

Nickel and other Transition Metal Based Catalyst System

As mentioned above, the catalyst system used for the polymerization of the 1,4-polybutadiene (ie. prior to hydrogenation) may utilize a nickel-based catalyst system comprising (i) a nickel compound, optionally in combination with an alcohol, (ii) an organoaluminum, organomagnesium, organozinc compound, or a combination thereof, and (iii) a fluorine-containing compound or a complex thereof. The particular compounds used for each of (i), (ii) and (iii) may vary.

According to certain embodiments, the nickel compound that is used in the nickel-based catalyst system may vary. The nickel atom in the nickel-containing compound can be in various oxidation states including but not limited to the 0, +2, +3, and +4 oxidation states. Suitable nickel-containing compounds for use in a nickel-based catalyst system according to the process of the first embodiment include, but are not limited to, nickel carboxylates, nickel carboxylate borates, nickel organophosphates, nickel organophosphonates, nickel organophosphinates, nickel carbamates, nickel dithiocarbamates, nickel xanthates, nickel diketonates, nickel alkoxides or aryloxides, nickel halides, nickel pseudo-halides, nickel oxyhalides, and organonickel compounds. In preferred embodiments, when a nickel-based catalyst system is used, the nickel compound is a nickel carboxylate.

Suitable nickel carboxylates can include nickel formate, nickel acetate, nickel acrylate, nickel methacrylate, nickel valerate, nickel gluconate, nickel citrate, nickel fumarate, nickel lactate, nickel maleate, nickel oxalate, nickel 2-ethylhexanoate, nickel neodecanoate, nickel naphthenate, nickel stearate, nickel oleate, nickel benzoate, and nickel picolinate.

Suitable nickel carboxylate borates may include compounds defined by the formulae (RCOONiO)3B or (RCOONiO)2B(OR), where each R, which may be the same or different, is a hydrogen atom or a mono-valent organic group. In one embodiment, each R may be a hydrocarbyl group such as, but not limited to, alkyl, cycloalkyl, substituted cycloalkyl, alkenyl, cycloalkenyl, substituted cycloalkenyl, aryl, substituted aryl, aralkyl, alkaryl, allyl, and alkynyl groups, with each group preferably containing from 1 carbon atom, or the appropriate minimum number of carbon atoms to form the group, up to about 20 carbon atoms. These hydrocarbyl groups may contain heteroatoms such as, but not limited to, nitrogen, oxygen, silicon, sulfur, and phosphorus atoms. Nickel carboxylate borate may include those disclosed in U.S. Pat. No. 4,522,988, which is incorporated herein by reference. Specific examples of nickel carboxylate borate include nickel(II) neodecanoate borate, nickel(II) hexanoate borate, nickel(II) naphthenate borate, nickel(II) stearate borate, nickel(II) octoate borate, nickel(II) 2-ethylhexanoate borate, and mixtures thereof.

Suitable nickel organophosphates can include nickel dibutyl phosphate, nickel dipentyl phosphate, nickel dihexyl phosphate, nickel diheptyl phosphate, nickel dioctyl phosphate, nickel bis(1-methylheptyl)phosphate, nickel bis(2-ethylhexyl)phosphate, nickel didecyl phosphate, nickel didodecyl phosphate, nickel dioctadecyl phosphate, nickel dioleyl phosphate, nickel diphenyl phosphate, nickel bis(p-nonylphenyl)phosphate, nickel butyl(2-ethylhexyl)phosphate, nickel (1-methylheptyl) (2-ethylhexyl)phosphate, and nickel (2-ethylhexyl) (p-nonylphenyl)phosphate.

Suitable nickel organophosphonates can include nickel butyl phosphonate, nickel pentyl phosphonate, nickel hexyl phosphonate, nickel heptyl phosphonate, nickel octyl phosphonate, nickel (1-methylheptyl)phosphonate, nickel (2-ethylhexyl)phosphonate, nickel decyl phosphonate, nickel dodecyl phosphonate, nickel octadecyl phosphonate, nickel oleyl phosphonate, nickel phenyl phosphonate, nickel (p-nonylphenyl)phosphonate, nickel butyl butylphosphonate, nickel pentyl pentylphosphonate, nickel hexyl hexylphosphonate, nickel heptyl heptylphosphonate, nickel octyl octylphosphonate, nickel (1-methylheptyl) (1-methylheptyl)phosphonate, nickel (2-ethylhexyl) (2-ethylhexyl)phosphonate, nickel decyl decylphosphonate, nickel dodecyl dodecylphosphonate, nickel octadecyl octadecylphosphonate, nickel oleyl oleylphosphonate, nickel phenyl phenylphosphonate, nickel (p-nonylphenyl) (p-nonylphenyl)phosphonate, nickel butyl(2-ethylhexyl)phosphonate, nickel (2-ethylhexyl)butylphosphonate, nickel (1-methylheptyl) (2-ethylhexyl)phosphonate, nickel (2-ethylhexyl) (1-methylheptyl)phosphonate, nickel (2-ethylhexyl) (p-nonylphenyl)phosphonate, and nickel (p-nonylphenyl) (2-ethylhexyl)phosphonate.

Suitable nickel organophosphinates can include nickel butylphosphinate, nickel pentylphosphinate, nickel hexylphosphinate, nickel heptylphosphinate, nickel octylphosphinate, nickel (1-methylheptyl)phosphinate, nickel (2-ethylhexyl)phosphinate, nickel decylphosphinate, nickel dodecylphosphinate, nickel octadecylphosphinate, nickel oleylphosphinate, nickel phenylphosphinate, nickel (p-nonylphenyl)phosphinate, nickel dibutylphosphinate, nickel dipentylphosphinate, nickel dihexylphosphinate, nickel diheptylphosphinate, nickel dioctylphosphinate, nickel bis(1-methylheptyl)phosphinate, nickel bis(2-ethylhexyl)phosphinate, nickel didecylphosphinate, nickel didodecylphosphinate, nickel dioctadecylphosphinate, nickel dioleylphosphinate, nickel diphenylphosphinate, nickel bis(p-nonylphenyl)phosphinate, nickel butyl(2-ethylhexyl)phosphinate, nickel (1-methylheptyl)(2-ethylhexyl)phosphinate, and nickel (2-ethylhexyl) (p-nonylphenyl)phosphinate.

Suitable nickel carbamates can include nickel dimethylcarbamate, nickel diethylcarbamate, nickel diisopropylcarbamate, nickel dibutylcarbamate, and nickel dibenzylcarbamate.

Suitable nickel dithiocarbamates can include nickel dimethyldithiocarbamate, nickel diethyldithiocarbamate, nickel diisopropyldithiocarbamate, nickel dibutyldithiocarbamate, and nickel dibenzyldithiocarbamate.

Suitable nickel xanthates include nickel methylxanthate, nickel ethylxanthate, nickel isopropylxanthate, nickel butylxanthate, and nickel benzylxanthate.

Suitable nickel diketonates can include nickel acetylacetonate, nickel trifluoroacetylacetonate, nickel hexafluoroacetylacetonate, nickel benzoylacetonate, and nickel 2,2,6,6-tetramethyl-3,5-heptanedionate.

Suitable nickel alkoxides or aryloxides can include nickel methoxide, nickel ethoxide, nickel isopropoxide, nickel 2-ethylhexoxide, nickel phenoxide, nickel nonylphenoxide, and nickel naphthoxide.

Suitable nickel halides can include nickel fluoride, nickel chloride, nickel bromide, and nickel iodide. Nickel pseudo-halides include nickel cyanide, nickel cyanate, nickel thiocyanate, nickel azide, and nickel ferrocyanide. Nickel oxyhalides include nickel oxyfluoride, nickel oxychloride and nickel oxybromide. Where the nickel halides, nickel oxyhalides or other nickel-containing compounds contain labile fluorine or chlorine atoms, the nickel-containing compounds can also serve as the fluorine-containing compound or the chlorine-containing compound. A Lewis base such as an alcohol can be used as a solubility aid for this class of compounds.

The term organonickel compound may refer to any nickel compound containing at least one nickel-carbon bond. Organonickel compounds include bis(cyclopentadienyl) nickel (also called nickelocene), bis(pentamethylcyclopentadienyl) nickel (also called decamethylnickelocene), bis(tetramethylcyclopentadienyl) nickel, bis(ethylcyclopentadienyl) nickel, bis(isopropylcyclopentadienyl) nickel, bis(pentadienyl)nickel, bis(2,4-dimethylpentadienyl)nickel, (cyclopentadienyl) (pentadienyl) nickel, bis(1,5-cyclooctadiene)nickel, bis(allyl)nickel, bis(methallyl)nickel, and bis(crotyl)nickel.

According to certain embodiments, the organoaluminum, organomagnesium compound, organozinc compound, or a combination thereof that is used for the (ii) component of the nickel-based catalyst system may vary. In preferred embodiments, when the polymerization process utilizes a nickel-based catalyst system, the component (ii) is an organoaluminum or organomagnesium compound, more preferably an organoaluminum compound. When the organoaluminum, organomagnesium, or organozinc compound includes labile fluorine it may also serve as the fluorine-containing compound (with no need for a separate fluorine-containing compound). In certain embodiments, the organoaluminum, organomagnesium or organozinc compound is devoid of chlorine or bromine atoms.

Suitable compounds for use as an organoaluminum compound or organomagnesium compound in a nickel-based catalyst system are discussed above in the section on lanthanide-based catalyst systems.

According to certain embodiments, the fluorine-containing compound that is used in the nickel-based catalyst system may vary. Suitable fluorine-containing compounds may include various compounds, or mixtures thereof, that contain one or more labile fluorine atoms. In one or more embodiments, the fluorine-containing compound may be soluble in a hydrocarbon solvent. In other embodiments, hydrocarbon-insoluble fluorine-containing compounds, which can be suspended in the polymerization medium to form the catalytically active species, may be useful.

Suitable types of fluorine-containing compounds include, but are not limited to, elemental fluorine, halogen fluorides, hydrogen fluoride, organic fluorides, inorganic fluorides, metallic fluorides, organometallic fluorides, and mixtures thereof. In one or more embodiments, the complexes of the fluorine-containing compounds with a Lewis base such as ethers, alcohols, water, aldehydes, ketones, esters, nitriles, or mixtures thereof may be employed. Specific examples of these complexes include the complexes of boron trifluoride and hydrogen fluoride with a Lewis base.

Halogen fluorides may include iodine monofluoride, iodine trifluoride, and iodine pentafluoride.

Organic fluorides may include t-butyl fluoride, allyl fluoride, benzyl fluoride, fluoro-di-phenylmethane, triphenylmethyl fluoride, benzylidene fluoride, methyltrifluorosilane, phenyltrifluorosilane, dimethyldifluorosilane, diphenyldifluorosilane, trimethylfluorosilane, benzoyl fluoride, propionyl fluoride, and methyl fluoroformate.

Inorganic fluorides may include phosphorus trifluoride, phosphorus pentafluoride, phosphorus oxyfluoride, boron trifluoride, silicon tetrafluoride, arsenic trifluoride, selenium tetrafluoride, and tellurium tetrafluoride.

Metallic fluorides may include tin tetrafluoride, aluminum trifluoride, antimony trifluoride, antimony pentafluoride, gallium trifluoride, indium trifluoride, titanium tetrafluoride, and zinc difluoride.

Organometallic fluorides may include dimethylaluminum fluoride, diethylaluminum fluoride, methylaluminum difluoride, ethylaluminum difluoride, methylaluminum sesquifluoride, ethylaluminum sesquifluoride, isobutylaluminum sesquifluoride, methylmagnesium fluoride, ethylmagnesium fluoride, butylmagnesium fluoride, phenylmagnesium fluoride, benzylmagnesium fluoride, trimethyltin fluoride, triethyltin fluoride, di-t-butyltin difluoride, dibutyltin difluoride, and tributyltin fluoride.

As mentioned above, when the polymerization process utilizes a nickel-based catalyst system, the nickel compound may be used in combination with an alcohol. Various alcohols and mixtures may be employed. In one or more embodiments, the alcohols include monohydric alcohols (i.e. those including one hydroxyl group), and in other embodiments the alcohols include multihydric alcohols (i.e. those including two or more hydroxyl groups) including dihydric alcohols, which may be referred to as glycols or diols, trihydric alcohols, which may be referred to as glycerols, and polyhydric alcohols. In one or more embodiments, the alcohols include primary and/or secondary alcohols. Primary and secondary alcohols include those alcohols wherein the α-carbon (i.e., the carbon adjacent to the carbon including the hydroxyl group) is primary or secondary. In certain preferred embodiments, when a nickel-based catalyst system is used, a monohydric alcohol, preferably hexanol is utilized.

The alcohols may include aliphatic alcohols, which include straight chain or branched alcohols. In other embodiments, the alcohols may include cyclic alcohols, in other embodiments, aromatic alcohols, in other embodiments heterocyclic alcohols, and in other embodiments polycyclic alcohols.

In these or other embodiments, the alcohols may be saturated, and in other embodiments they may unsaturated. In certain embodiments, useful alcohols include those alcohols that are soluble, or at least partially soluble, within the reaction medium in which the polymerization takes place.

In one or more embodiments, useful alcohols may be defined by the formula R—OH, where R is a monovalent organic group, and —OH is a hydroxyl group. Monovalent organic groups may include hydrocarbyl groups or substituted hydrocarbyl groups such as, but not limited to alkyl, cycloalkyl, substituted cycloalkyl, alkenyl, cycloalkenyl, substituted cycloalkenyl, aryl, allyl, substituted aryl, aralkyl, alkaryl, and alkynyl groups. Substituted groups include those groups where a hydrogen atom of the group is itself replaced by a monovalent organic group. These hydrocarbyl groups may contain heteroatoms such as, but not limited to, nitrogen, oxygen, silicon, tin, sulfur, boron, and phosphorous atoms. In certain embodiments, the hydrocarbyl group may be devoid of halogen atoms such as a chlorine or bromine atom. In certain embodiments, the monovalent organic group may contain one or more hydroxyl groups attached thereto. As a result, the alcohol may contain two or more hydroxyl groups. In other embodiments, the hydrocarbyl groups are devoid of heteroatoms.

In one or more embodiments, useful alcohols include from 1 to about 40 carbon atoms, in other embodiments from about 2 to about 26 carbon atoms, in other embodiments from about 4 to about 18 carbon atoms, and in other embodiments from about 6 to about 12 carbon atoms.

Exemplary aliphatic alcohols include methanol, ethanol, propanol, isopropanol, n-butanol, t-butanol, isobutanol, n-pentanol, n-hexanol, 2-ethyl hexanol, n-heptanol, octanol, decanol, and mixtures thereof.

Exemplary cyclic alcohols include cyclohexanol, methanol, t-butyl cyclohexanol, cyclopentanol, cycloheptanol, cyclooctanol, and mixtures thereof.

Exemplary unsaturated alcohols include allyl alcohol, and mixtures thereof.

Exemplary aromatic alcohols include substituted phenol, phenol, benzyl alcohol, and mixtures thereof.

Exemplary heterocyclic alcohols include furfuryl alcohol, and mixtures thereof.

Exemplary polycyclic alcohols include sterols, and mixtures thereof.

The foregoing catalyst compositions may have high catalytic activity for polymerizing conjugated dienes into stereospecific polydienes over a wide range of catalyst concentrations and catalyst ingredient ratios. It is believed that the catalyst ingredients may interact to form an active catalyst species. It is also believed that the optimum concentration for any one catalyst ingredient may be dependent upon the concentration of the other catalyst ingredients.

In one or more embodiments, the molar ratio of the (ii) component to the nickel-containing compound can be varied from about 1:1 to about 200:1, in other embodiments from about 3:1 to about 30:1, and in other embodiments from about 5:1 to about 15:1. The term molar ratio, as used herein, refers to the equivalent ratio of relevant components of the ingredients, e.g., the ratio of equivalents of aluminum atoms on the aluminum-containing compound to equivalents of nickel atoms on the nickel-containing compound. In other words, where difunctional or polyfunctional compounds (e.g., those compounds including two or more carboxylic acid groups) are employed, fewer moles of the compound are required to achieve the desired equivalent ratio.

In one or more embodiments, the molar ratio of the fluorine-containing compound to the nickel-containing compound (F/Ni) can be varied from about 7:1 to about 500:1, in other embodiments from about 7.5:1 to about 450:1, and in other embodiments from about 8:1 to about 400:1.

In one or more embodiments, the molar ratio of the alcohol to the nickel-containing compound (—OH/Ni) can be varied from about 0.4:1 to about 80:1, in other embodiments from about 0.5:1 to about 75:1, and in other embodiments from about 0.7:1 to about 65:1. The term molar ratio, as used herein, refers to the equivalent ratio of relevant components of the ingredients, e.g., the ratio of equivalents of chlorine atoms on the chlorine-containing compound to equivalents of nickel atoms on the nickel-containing compound.

Generally, the nickel-based catalyst system may be formed by combining or mixing the catalyst ingredients. Although an active catalyst species is believed to result from this combination, the degree of interaction or reaction between the various ingredients or components is not known with any great degree of certainty. Therefore, the term “catalyst system” has been employed to encompass a simple mixture of the ingredients, a complex of the various ingredients that is caused by physical or chemical forces of attraction, a chemical reaction product of the ingredients, or a combination of the foregoing.

The nickel-based catalyst system can be formed by using one of the following methods. In one or more embodiments, the nickel-based catalyst system may be formed in situ by adding the catalyst ingredients to a solution containing monomer and solvent or simply bulk monomer, in either a stepwise or simultaneous manner. In one embodiment, a mixture of the (ii) component, the nickel-containing compound, and the alcohol (when present) is formed. This mixture may be formed within a solvent. This mixture and the fluorine-containing compound may then be added to the monomer to be polymerized.

In one or more embodiments, the selected catalyst ingredients of the nickel-based catalyst system may be pre-mixed outside the polymerization system at an appropriate temperature, which may be from about 20° C. to about 80° C., and the resulting catalyst system may be aged for a period of time ranging from a few seconds to a few days and then added to the monomer.

In one or more embodiments, the mixture of the (ii) component, nickel-containing compound, and alcohol (when present) is formed in the presence of a small amount of monomer and optionally a solvent. That is, the selected catalyst ingredients may be formed in the presence of a small amount of conjugated diene monomer at an appropriate temperature, which may be from about 20° C. to about 80° C. The amount of conjugated diene monomer that may be used to form this mixture can range from about 1 to about 500 moles per mole, in other embodiments from about 5 to about 250 moles per mole, and in other embodiments from about 10 to about 100 moles per mole of the nickel-containing compound. The resulting composition may be aged for a period of time ranging from a few seconds to a few days and then added to the remainder of the conjugated diene monomer that is to be polymerized together with the fluorine-containing compound.

When a solution of the nickel-based catalyst system or one or more of the catalyst ingredients thereof is prepared outside the polymerization system as set forth in the foregoing methods, an organic solvent or carrier may be employed. The organic solvent may serve to dissolve the catalyst composition or ingredients, or the solvent may simply serve as a carrier in which the catalyst composition or ingredients may be suspended. The organic solvent may be inert to the catalyst composition. Useful solvents include hydrocarbon solvents such as aromatic hydrocarbons, aliphatic hydrocarbons, cycloaliphatic hydrocarbons and/or a mixture of two or more thereof. Non-limiting examples of aromatic hydrocarbon solvents include benzene, toluene, xylenes, ethylbenzene, diethylbenzene, mesitylene, and the like. Non-limiting examples of aliphatic hydrocarbon solvents include n-pentane, n-hexane, n-heptane, n-octane, n-nonane, n-decane, isopentane, isohexanes, isopentanes, isooctanes, 2,2-dimethylbutane, petroleum ether, kerosene, petroleum spirits, and the like. And, non-limiting examples of cycloaliphatic hydrocarbon solvents include cyclopentane, cyclohexane, methylcyclopentane, methylcyclohexane, and the like. Commercial mixtures of the above hydrocarbons may also be used.

Various hydrogenation methods are contemplated as suitable for hydrogenating the 1,4-polybutadiene to form the partially hydrogenated 1,4-polybutadiene of the present disclosure. In embodiments, the hydrogenation reaction pressures may be from about 100 kPa to about 2500 kPa. In certain embodiments, the hydrogenation reaction temperature may be from about 20° C. to about 200° C. The hydrogenation reaction time depends upon the degree of saturation to be obtained and the amount of initial unsaturation. In one or more embodiments, the hydrogenation reaction time may be from about 0.5 hr. to about 5 hr.

In certain embodiments, hydrogenation is carried out in a solution in an inert hydrocarbon. In other embodiments, hydrogenation is carried using a heterogeneous hydrogenation catalyst.

In embodiments, the hydrogenation catalyst is a metal catalyst.

In certain embodiments, the metal catalyst for hydrogenation may comprise aluminum, such as an organoaluminum compound. The organoaluminum compound may be the same as or similar to the organoaluminum compounds described hereinabove with respect to the catalyst used for the polymerization of the 1,4-polybutadiene (i.e., prior to hydrogenation).

In certain embodiments, the metal catalyst for hydrogenation may comprise transition metal compounds, such as nickel, ruthenium, rhodium, palladium, iridium, platinum, or combinations thereof.

The transition metal atom in the transition metal compounds can be in various oxidation states including but not limited to the 0, +2, +3, and +4 oxidation states. Transition metal compounds include, but are not limited to, metal carboxylates, metal carboxylate borates, metal organophosphates, metal organophosphonates, metal organophosphinates, metal carbamates, metal dithiocarbamates, metal xanthates, metal β-diketonates, metal alkoxides or aryloxides, metal halides, metal pseudo-halides, metal oxyhalides, and organometal compounds.

The nickel compound used for hydrogenation may be the same as or similar to the nickel compounds described hereinabove with respect to the catalyst used for the polymerization of the 1,4-polybutadiene. Without wishing to limit the practice of the methods disclosed herein, the discussion herein focuses on nickel compounds, although those skilled in the art will be able to select similar compounds that are based upon other transition metals.

In some embodiments, the hydrogenation catalyst may include comprise at least one nickel compound and at least one aluminum compound. For hydrogenation catalysts including nickel and aluminum, the aluminum may also include an organic aluminum compound. The nickel and aluminum may be included in various amounts. For example, the aluminum and nickel may be added at an Al/Ni molar ratio of 1:1 to 5:1, or from 2:1 to 4:1.

### EXAMPLES

The polymers described herein will be further described in the following examples, which are not intended to restrict the polymers.

### Measurements

The number average molecular weight (Mn) and weight average molecular weight (Mw) were determined by gel permeation chromatography using a TOSOH Esosec HLC-8320 GPC system and TOSOH TSKgel GMHxl-BS columns with THF as the solvent. The system was calibrated using polystyrene standards.

The cis content, vinyl content, and hydrogenation level were determined by ¹H-Nuclear Magnetic Resonance spectroscopy in tetrachloroethane-d2 at 80° C.

“Enthalpy of melting ΔHₘ” and “glass transition temperature T_{g}” were measured by differential scanning calorimetry. The differential scanning calorimerty method included a starting temperature of 23° C., heating to 200° C. at a 10° C./min ramp rate, cooling to −120° C., and reheating to 200° C. at a 10° C./min ramp rate.

### Example 1—Synthesis of high-cis 1,4-polybutadiene

To a nitrogen-purged reactor, 113.09 g of anhydrous hexane and 219.90 g of 21.2 wt % 1,3-butadiene in hexane was added. 0.25 mL of 1.0 M diisobutylaluminum in hexane and 0.452 M neodymium finish catalyst (COMCAT Nd—FC from Comar Chemicals) in hexane were sequentially added to the mixture in the reactor. The mixture was placed in an agitating bath at 50° C. After 60 min. of agitation, the polymerization was terminated by charging the polymerization mixture with 0.1 ml of isopropanol to produce Polymer A, a high-cis 1,4-polybutadiene, the properties of which are shown in Table 1.

TABLE 1
Properties of Polymer A

| cis content (%) | vinyl content (%) | Mₙ (g/mol) | M_{w} (g/mol) |
|---|---|---|---|
| 96.13 | 0.25 | 66,593 | 144,012 |

### Example 2—Hydrogenation of high-cis 1,4-polybutadiene

To each of 3 Optimization Sample Reactors of the Unchained Synthesis Unit under a nitrogen atmosphere, 20 mL of Polymer A from Example 1 in hexane was introduced and the reactors were sealed. The reactor was purged three times with 345 kPa hydrogen and the reactor jacket was heated to 50° C. To a nitrogen purged dry bottle, 11.5 mL of hexane and 0.63 mL of 1.03 M triethylaluminum was added, followed by 0.70 mL of nickel octoate (1.59 wt % nickel in hexane), resulting in a Ni/Al catalyst (Al/Ni=3.3/1.0). The reactor was pressured to 517 kPa with hydrogen and 1.0 mL of the Ni/Al catalyst was transferred to each reactor. After between 15 to 180 min. of hydrogenation reaction, hydrogen was released from the reactor and the polymer was coagulated and drum dried at 120° C. to produce Hydrogenated Polymers HA, HB, and HC, hydrogenated high-cis 1,4-polybutadienes. The properties of Polymer A and Hydrogenated Polymers HA, HB, and HC are shown in Table 2.

TABLE 2
Properties of Polymer A and Hydrogenated
Polymers HA, HB, and HC

| | | Hydro- | Hydro- | Hydro- |
|---|---|---|---|---|
| | | genated | genated | genated |
| | Polymer | Polymer | Polymer | Polymer |
| | A | HA | HB | HC |
| Hydrogenation | 0 | 5 | 9 | 15 |
| Reaction Time | | | | |
| (min) | | | | |
| Hydrogenation (%) | 0 | 8 | 24 | 32 |
| Cis Content (%) | 96.0 | 87.0 | 68.2 | 60.3 |
| Vinyl Content (%) | 0.3 | 0.4 | 0.3 | 0.3 |
| Trans Content (%) | 3.7 | 4.4 | 7.2 | 7.9 |
| T_{g} (° C.) | −105.7 | −106.0 | −105.6 | −105.9 |
| Tₘ₁ (° C.) | −7.7 | −9.9 | −17.9 | −22.8 |
| ΔHₘ₁ (J/g) | 46.5 | 38.7 | 36.7 | 6.1 |
| Tₘ₂ (° C.) | — | 108.0 | 112.0 | 113.2 |
| ΔHₘ₂ (J/g) | — | 0.8 | 12.1 | 11.1 |

Hydrogenated Polymers HA, HB, and HC, having a degree of hydrogenation of 9%, 25%, and 35%, respectively, had a lower first enthalpy of melting ΔHₘ₁ (J/g) as compared to Polymer A, indicating a resistance to crystallite formation of cis-1,4-butadiene units. As exemplified by Table 2, hydrogenated high-cis 1,4-polybutadiene, even at relatively low levels of hydrogenation (e.g., less than or equal to 10%), has improved resistance to crystallite formation of cis-1,4-butadiene units.

Hydrogenated Polymers HB and HC had a higher high temperature enthalpy of melting ΔHₘ₂ (J/g) as compared to Hydrogenated Polymer HA, indicating increased formation of crystallites resulting from hydrogenation. As exemplified by Table 2, as the degree of the hydrogenation of the high-cis 1,4-polybutadiene increases, the hydrogenated high-cis 1,4-polybutadiene exhibits increased formation of crystallites resulting from hydrogenation.

Hydrogenated Polymers HA, HB, and HC have a similar glass transition temperature T_{g} as Polymer A. As exemplified by Table 2, hydrogenated high-cis 1,4-polybutadiene maintains a relatively low glass transition temperature T_{g}, which may be useful for obtaining good wear resistance of tire tread and snow traction.

Embodiments may be further described with respect to the clauses below:
1. A polymer comprising: partially hydrogenated 1,4-polybutadiene having a cis content of about 50% to about 96%, a vinyl content of about 0% to about 1%, and a trans content of about 1% to about 10%, wherein the partially hydrogenated 1,4-polybutadiene has a degree of hydrogenation of about 3% to about 50%.
2. The polymer of any preceding clause, wherein the partially hydrogenated 1,4-polybutadiene has a degree of hydrogenation of about 5% to about 50%.
3. The polymer of any preceding clause, wherein the degree of hydrogenation is about 10% to about 50%, or 15% to about 50%, or about 20% to about 50%.
4. The polymer of any preceding clause, wherein the hydrogenated 1,4-polybutadiene has a glass transition temperature T_{g} of about −115° C. to about −95° C.
5. The polymer of any preceding clause, wherein the hydrogenated 1,4-polybutadiene has a first melting temperature Tₘ₁ of about −30° C. to about 0° C.
6. The polymer of any preceding clause, wherein the hydrogenated 1,4-polybutadeiene has a second melting temperature of about 100° C. to about 140° C.
7. The polymer of any preceding clause, wherein the hydrogenated 1,4-polybutadiene has a first enthalpy of melting ΔHₘ₁ of about 3 J/g to about 50 J/g as measured at a temperature of about −30° C. to about 0° C.
8. The polymer of any preceding clause, wherein the hydrogenated 1,4-polybutadiene has a first enthalpy of melting ΔHₘ₁ of about 0 J/g to about 45 J/g as measured at a temperature of about −30° C. to about 0° C.
9. The polymer of any preceding clause, wherein the hydrogenated 1,4-polybutadiene has a second enthalpy of melting ΔHₘ₂ of about 0.5 J/g to about 20 J/g as measured at a temperature of up to about 140° C.
10. The polymer of any preceding clause, wherein the hydrogenated 1,4-polybutadiene has a second enthalpy of melting ΔHₘ₂ of about 0 J/g to about 20 J/g as measured at a temperature of up to about 140° C.
11. The polymer of any preceding clause, wherein the hydrogenated 1,4-polybutadiene has a weight average molecular weight M_{w} of about 100,000 g/mol to about 500,000 g/mol.
12. The polymer of any preceding clause, having: polymer chains bonded to a residue of a functionalizing compound having formula (I) as follows

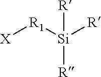

wherein X is a group reactive with the living end polymer chains and is selected from the group consisting of cyano, epoxy, ketone, aldehyde, ester, and acid anhydrides, wherein R₁ is selected from hydrocarbylene of C₁-C₂₀, wherein each R′ is selected from alkoxy or carboxy of C₁-C₂₀, wherein R″ is selected from alkyl, alkoxy, or carboxy of C₁-C₂₀ and aryl of C₆-C₂₀, and wherein each polymer chain is bonded to the residue of the functionalizing compound through the X group.
13. The polymer of any preceding clause, wherein X of formula (I) is an epoxy group.
14. The polymer of any preceding clause, wherein X of formula (I) is a glycidoxy group and the polymer chains are bonded to a carbon atom from the epoxy group.
15. The polymer of any preceding clause, wherein X of formula (I) is a cyano group.
16. A rubber composition comprising: the polymer of any preceding clause, reinforcing filler; and a curative.
17. The rubber composition of any preceding clause, wherein the rubber composition comprises about 20 phr to about 50 phr of the polymer of claim 1.
18. The rubber composition of any preceding clause, wherein the reinforcing filler comprises carbon black, silica, or combinations thereof, and the curative comprises sulfur.
19. The rubber composition of any preceding clause, wherein the reinforcing filler comprises about 1 phr to about 60 phr carbon black.
20. The rubber composition of any preceding clause, wherein the reinforcing filler comprises about 25 phr to about 150 phr silica.
21. The rubber composition of any preceding clause, further comprising natural rubber, synthetic rubber, or combinations thereof.
22. The rubber composition of any preceding clause, wherein the synthetic rubber comprises polybutadiene, polyisoprene, polyisobutylene-co-isoprene, neoprene, poly(ethylene-co-propylene), poly(styrene-co-butadiene), poly(styrene-co-isoprene), and poly(styrene-co-isoprene-co-butadiene), poly(isoprene-co-butadiene), poly(ethylene-co-propylene-co-diene), polysulfide rubber, acrylic rubber, urethane rubber, silicone rubber, epichlorohydrin rubber, or combinations thereof.
23. The rubber composition of any preceding clause, wherein the rubber composition comprises about 1 phr to about 90 phr of the natural rubber, the synthetic rubber, or combinations thereof.
24. A method comprising: polymerizing a solution comprising 1,3-butadiene to yield 1,4-polybutadiene having a cis content of about 50% to about 99.5%, a vinyl content of about 0.1% to about 1%, and a trans content of about 1% to about 10%, wherein the polymerization is catalyzed with a lanthanide metal complex or a nickel metal complex; and hydrogenating the 1,4-polybutadiene to form hydrogenated 1,4-polybutadiene having a degree of hydrogenation of about 3% to about 50%, wherein the hydrogenation is catalyzed with a metal catalyst.
25. The method of any preceding clause, wherein the partially hydrogenated 1,4-polybutadiene has a degree of hydrogenation of about 5% to about 50%
26. The method of any preceding clause, wherein the hydrogenated 1,4-polybutadiene has a cis content of about 50% to about 95%, a vinyl content of about 0% to about 1% %, and a trans content of about 1% to about 10%.
27. The method of any preceding clause, wherein the lanthanide metal complex comprises one or more of lanthanum, neodymium, cerium, praseodymium, promethium, samarium, europium, gadolinium, terbium, dysprosium, holmium, erbium, thulium, ytterbium, lutetium, and didymium.
28. The method of any preceding clause, wherein the lanthanide metal complex comprises neodymium.
29. The method of any preceding clause, wherein the nickel metal complex comprises one or more of nickel carboxylates, nickel carboxylate borates, nickel organophosphates, nickel organophosphonates, nickel organophosphinates, nickel carbamates, nickel dithiocarbamates, nickel xanthates, nickel diketonates, nickel alkoxides or aryloxides, nickel halides, nickel pseudo-halides, nickel oxyhalides, and organonickel compounds
30. The method of any preceding clause, wherein the nickel metal complex comprises nickel carboxylate.
31. The method of any preceding clause, wherein the metal catalyst comprises nickel, aluminum, ruthenium, rhodium, palladium, iridium, platinum, or combinations thereof.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects:

What is claimed is:

1. A polymer comprising:
partially hydrogenated 1,4-polybutadiene having a cis content of about 50% to about 96%, a vinyl content of about 0% to about 1%, and a trans content of about 1% to about 10%,
wherein the partially hydrogenated 1,4-polybutadiene has a degree of hydrogenation of about 3% to about 50%.

2-3. (canceled)

4. The polymer of claim 1, wherein the hydrogenated 1,4-polybutadiene has a glass transition temperature T_{g} of about −115° C. to about −95° C.

5. The polymer of claim 1, wherein the hydrogenated 1,4-polybutadiene has a first melting temperature Tₘ₁ of about −30° C. to about 0° C.

6. The polymer of claim 1, wherein the hydrogenated 1,4-polybutadeiene has a second melting temperature of about 100° C. to about 140° C.

7. The polymer of claim 1, wherein the hydrogenated 1,4-polybutadiene has a first enthalpy of melting ΔHₘ₁ of about 3 J/g to about 50 J/g as measured at a temperature of about −30° C. to about 0° C.

8. The polymer of claim 1, wherein the hydrogenated 1,4-polybutadiene has a first enthalpy of melting ΔHₘ₁ of about 0 J/g to about 45 J/g as measured at a temperature of about −30° C. to about 0° C.

9. The polymer of claim 1, wherein the hydrogenated 1,4-polybutadiene has a second enthalpy of melting ΔHₘ₂ of about 0.5 J/g to about 20 J/g as measured at a temperature of up to about 140° C.

10. The polymer of claim 1, wherein the hydrogenated 1,4-polybutadiene has a second enthalpy of melting ΔHₘ₂ of about 0 J/g to about 20 J/g as measured at a temperature of up to about 140° C.

11. The polymer of claim 1, wherein the hydrogenated 1,4-polybutadiene has a weight average molecular weight M, of about 100,000 g/mol to about 500,000 g/mol.

12. The polymer of claim 1, having:
polymer chains bonded to a residue of a functionalizing compound having formula (I) as follows 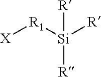
wherein X is a group reactive with the living end polymer chains and is selected from the group consisting of cyano, epoxy, ketone, aldehyde, ester, and acid anhydrides,
wherein R₁ is selected from hydrocarbylene of C₁-C₂₀,
wherein each R′ is selected from alkoxy or carboxy of C₁-C₂₀,
wherein R″ is selected from alkyl, alkoxy, or carboxy of C₁-C₂₀ and aryl of C₆-C₂₀, and
wherein each polymer chain is bonded to the residue of the functionalizing compound through the X group.

13-15. (canceled)

16. A rubber composition comprising:
the polymer of claim 1;
reinforcing filler; and
a curative.

17. The rubber composition of claim 16, wherein the rubber composition comprises about 20 phr to about 50 phr of the polymer of claim 1.

18. The rubber composition of claim 16, wherein the reinforcing filler comprises carbon black, silica, or combinations thereof, and the curative comprises sulfur.

19. The rubber composition of claim 18, wherein the reinforcing filler comprises about 1 phr to about 60 phr carbon black.

20. The rubber composition of claim 18, wherein the reinforcing filler comprises about 25 phr to about 150 phr silica.

21. The rubber composition of claim 16, further comprising natural rubber, synthetic rubber, or combinations thereof.

22-23. (canceled)

24. A method comprising:
polymerizing a solution comprising 1,3-butadiene to yield 1,4-polybutadiene having a cis content of about 50% to about 99.5%, a vinyl content of about 0.1% to about 1%, and a trans content of about 1% to about 10%, wherein the polymerization is catalyzed with a lanthanide metal complex or a nickel metal complex; and
hydrogenating the 1,4-polybutadiene to form hydrogenated 1,4-polybutadiene having a degree of hydrogenation of about 3% to about 50%, wherein the hydrogenation is catalyzed with a metal catalyst.

25-26. (canceled)

27. The method of claim 24, wherein the lanthanide metal complex comprises one or more of lanthanum, neodymium, cerium, praseodymium, promethium, samarium, europium, gadolinium, terbium, dysprosium, holmium, erbium, thulium, ytterbium, lutetium, and didymium.

28. (canceled)

29. The method of claim 24, wherein the nickel metal complex comprises one or more of nickel carboxylates, nickel carboxylate borates, nickel organophosphates, nickel organophosphonates, nickel organophosphinates, nickel carbamates, nickel dithiocarbamates, nickel xanthates, nickel diketonates, nickel alkoxides or aryloxides, nickel halides, nickel pseudo-halides, nickel oxyhalides, and organonickel compounds

30. (canceled)

31. The method of claim 24, wherein the metal catalyst comprises nickel, aluminum, ruthenium, rhodium, palladium, iridium, platinum, or combinations thereof.
